(19) United States
(12) Patent Application Publication
(10) Pub. No.: US 2026/0109794 A1
(43) Pub. Date: Apr. 23, 2026

(54) BIMODAL CATALYST SYSTEM AND POLYMERIZATION PROCESS

(71) Applicant: Dow Global Technologies LLC, Midland, MI (US)

(72) Inventors: Dharati Joshi Koenigs, Pearland, TX (US); Rhett A. Baillie, Missouri City, TX (US)

(21) Appl. No.: 19/153,087

(22) PCT Filed: Jan. 24, 2025
(86) PCT No.: PCT/US2025/012902

§ 371 Date: Aug. 1, 2025

Related U.S. Application Data
(60) Provisional application No. 63/551,774, filed on Feb. 9, 2024.
(60) Provisional application No. 63/551,792, filed on Feb. 9, 2024.
(60) Provisional application No. 63/551,814, filed on Feb. 9, 2024.

(51) Int. Cl. C08F 210/16

(52) U.S. Cl. CPC C08F 210/16

(57) ABSTRACT

The present disclosure provides a catalyst system. In an embodiment, the catalyst composition includes (A) a phenoxy imine precatalyst having a structure of Formula 1: (I) wherein M¹ is a metal selected from Ti, Zr, or Hf; each X¹ is independently a halogen atom; R¹ and R⁵ each is independently selected from substituted/unsubstituted (C₁-C₂₀)hydrocarbyl, substituted/unsubstituted (C₁-C₂₀)heterohydrocarbyl; R³ and R⁷ each is independently selected from substituted/unsubstituted (C₁-C₂₀)hydrocarbyl, substituted/unsubstituted (C₁-C₂₀)heterohydrocarbyl, and a substituted (C₁-C₂₀)heterohydrocarbyl; and R², R⁴, R⁶, and R⁸ each is hydrogen. The catalyst composition also includes (B) a metallocene precatalyst having a structure of Formula 2: (II) wherein M2 is a metal selected from Ti, Zr, or Hf;

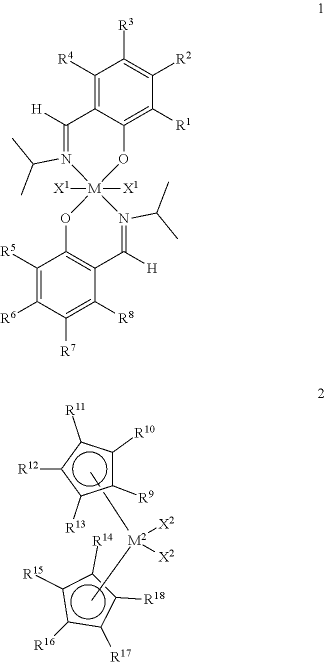

### BACKGROUND

Gas-phase single reactor technologies provide for the synthesis of olefin copolymers (and ethylene/α-olefin copolymers in particular) polymerized with a high molecular weight component and a low molecular weight component (also known as a bimodal copolymer). However, utilization of a single polymerization reactor limits the comonomer distribution across the high molecular weight component (“HMW”) and the low molecular weight component (“LMW”) of the bimodal copolymer. Polymers with proportionally more comonomer content in the HMW component are known to exhibit an improved balance of various product properties, such as improved balance of slow crack growth resistance (SCGR) and long-term hydrostatic test performance (for pipes); improved abuse properties (i.e. DART) and processability for linear low density blown and cast films; improved balance of environmental stress cracking resistance (ESCR) and swell properties for (blow molded articles); and improved balance of ESCR and processability for wire and cable applications.

The art recognizes the need for a catalyst system for use in a single polymerization reactor configuration capable of producing ethylene copolymer, and ethylene/α-olefin copolymer in particular, with increased comonomer content in the HMW component for improved product performance.

### SUMMARY

The present disclosure provides a catalyst system. In an embodiment, the catalyst composition includes (A) a phenoxy imine precatalyst having a structure of Formula 1:

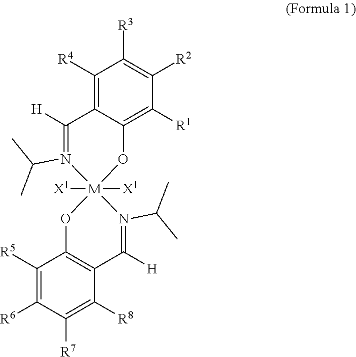

wherein
M¹ is a metal selected from the group consisting of Ti, Zr, and Hf;
each X¹ is independently a halogen atom;
R¹ and R⁵ each is independently selected from the group consisting of a substituted (C₁-C₂₀)hydrocarbyl, an unsubstituted (C₁-C₂₀)hydrocarbyl, a substituted (C₁-C₂₀)heterohydrocarbyl, and a substituted (C₁-C₂₀)heterohydrocarbyl;
R³ and R⁷ each is independently selected from the group consisting of a substituted (C₁-C₂₀)hydrocarbyl, an unsubstituted (C₁-C₂₀)hydrocarbyl, a substituted (C₁-C₂₀)heterohydrocarbyl, and a substituted (C₁-C₂₀)heterohydrocarbyl; and
R², R⁴, R⁶, and R⁸ each is hydrogen. The catalyst composition also includes (B) a metallocene precatalyst having a structure of Formula 2:

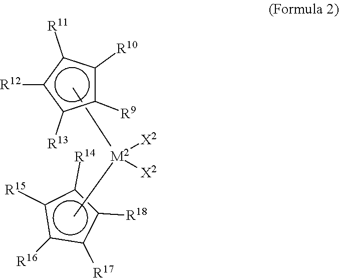

wherein
M² is a metal selected from the group consisting of Ti, Zr, and Hf;
each X² is independently selected from the group consisting of a (C₁-C₁₀)heterohydrocarbyl and a halogen atom;
R⁹, R¹⁰, R¹¹, R¹², R¹, R¹⁴, R¹⁵, R¹⁶, R¹⁷, and R¹⁸ each is independently selected from the group consisting of a substituted (C₁-C₁₀)hydrocarbyl, an unsubstituted (C₁-C₁₀)hydrocarbyl, a substituted (C₁-C₁)heterohydrocarbyl, an unsubstituted (C₁-C₁₀)heterohydrocarbyl, and hydrogen with the proviso that any two adjacent of R⁹-R¹³ may be optionally connected to form a ring structure and any two adjacent of R¹⁴-R¹⁸ may be optionally connected to form a ring structure

The present disclosure provides a process for producing a supported catalyst system. In an embodiment, the process for producing a supported catalyst system includes providing a mixture comprising an activator and a support material suspended in an inert hydrocarbon liquid; and adding to the mixture (B) a metallocene precatalyst having a structure of Formula (2), to form a precursor activated catalyst slurry (PACS). The process includes spray drying the PACS and forming particles of a spray-dried supported activated metallocene catalyst system (SD-SAMCS). The process includes preparing a slurry comprising the SD-SAMCS in an inert liquid, and contacting the SD-SAMCS slurry with a trim solution comprising (A) a phenoxy imine precatalyst having a structure of Formula (1) in an inert hydrocarbon liquid. The process includes forming a spray-dried supported activated bimodal catalyst system (SD-SABCS).

The present disclosure provides a process. In an embodiment, the process includes polymerizing ethylene with optionally one or more α-olefins, under polymerization conditions, with an activated catalyst system. The activated catalyst system includes (A) a phenoxy imine precatalyst having a structure of Formula 1:

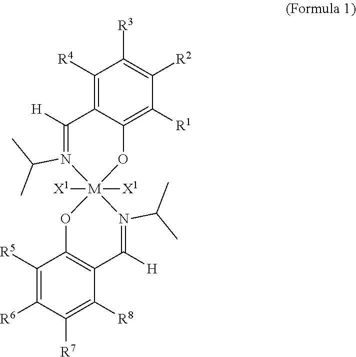

wherein
M¹ is a metal selected from the group consisting of Ti, Zr, and Hf;
each X¹ is independently a halogen atom;
R¹ and R⁵ each is independently selected from the group consisting of a substituted (C₁-C₂₀)hydrocarbyl, an unsubstituted (C₁-C₂₀)hydrocarbyl, a substituted (C₁-C₂₀)heterohydrocarbyl, and a substituted (C₁-C₂₀)heterohydrocarbyl;
R³ and R⁷ each is independently selected from the group consisting of a substituted (C₁-C₂₀)hydrocarbyl, an unsubstituted (C₁-C₂₀)hydrocarbyl, a substituted (C₁-C₂₀)heterohydrocarbyl, and a substituted (C₁-C₂₀)heterohydrocarbyl; and
R², R⁴, R⁶, and R⁸ each is hydrogen. The activated catalyst system includes (B) a metallocene precatalyst having a structure of Formula 2

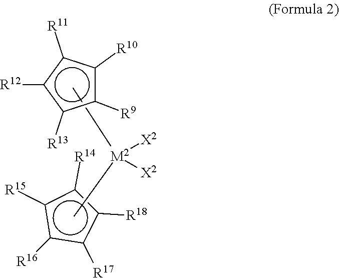

wherein
M² is a metal selected from the group consisting of Ti, Zr, and Hf;
each X² is independently selected from the group consisting of a (C₁-C₁₀)heterohydrocarbyl and a halogen atom;
R⁹, R¹⁰, R¹¹, R¹², R¹³, R¹⁴, R¹⁵, R¹⁶, R¹⁷, and R¹⁸ each is independently selected from the group consisting of a substituted (C₁-C₁₀)hydrocarbyl, an unsubstituted (C₁-C₁₀)hydrocarbyl, a substituted (C₁-C₁₀)heterohydrocarbyl, an unsubstituted (C₁-C₁₀)heterohydrocarbyl, and hydrogen with the proviso that any two adjacent of R⁹-R¹³ may be optionally connected to form a ring structure and any two adjacent of R¹⁴-R¹⁸ may be optionally connected to form a ring structure. The activated catalyst system includes (C) an activator selected from the group consisting of aluminoxane and methylaluminoxane (MAO). The activated catalyst system includes (D) a support material comprising fumed silica. The process includes forming a bimodal ethylene/α-olefin copolymer.

### BRIEF DESCRIPTION OF THE DRAWINGS

FIG. 1 shows molecular weight comonomer distribution index (MWCDI) for inventive example (IE) 5. The GPC trace is divided into two along the midpoint shown, and then Mw is calculated for each of the low molecular weight, i.e., LMW-Mw, and the high molecular weight, i.e., HMW-Mw. The wt % comonomer at each LMW-Mw and HMW-Mw is used to make a line, the slope of which is the MWCDI value, which is 13.04 for IE5.

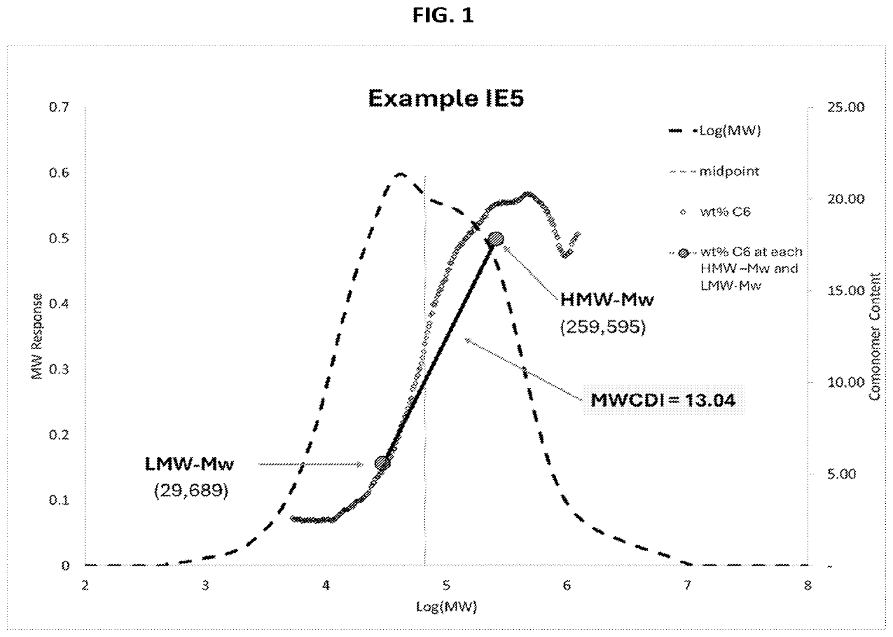

FIG. 2 shows compositional GPC traces for CS3, CS4, IE3, IE4, and IF 5.

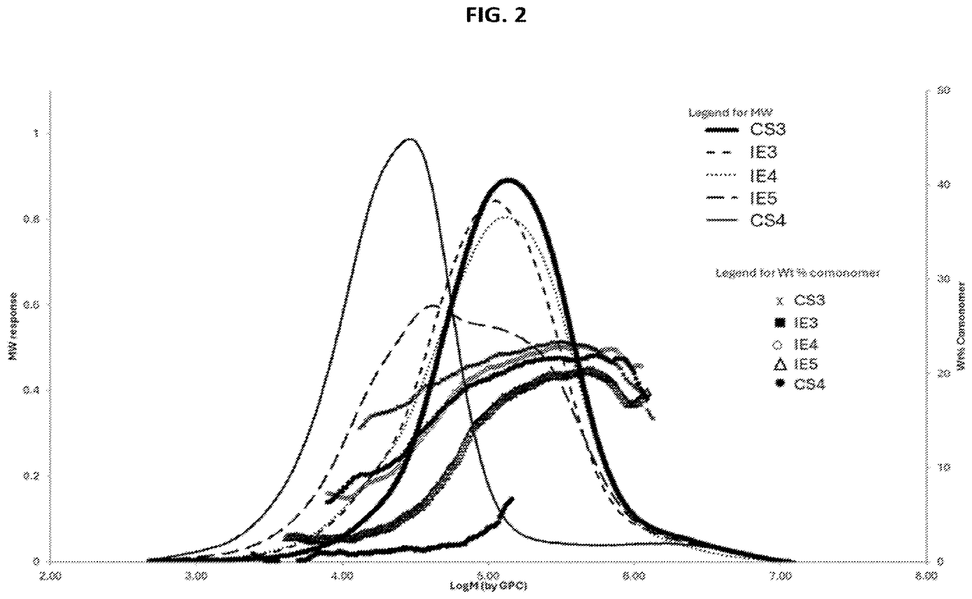

### DEFINITIONS

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., 1 or 2; or 3 to 5; or 6; or 7), any subrange between any two explicit values is included (e.g., 1 to 2; 2 to 6; 5 to 7; 3 to 7; 5 to 6; etc.).

Unless stated to the contrary, implicit from the context, or customary in the art, all parts and percents are based on weight and all test methods are current as of the filing date of this disclosure.

Common abbreviations used herein are: Me, methyl; Ph, phenyl; Bn, benzyl; i-Pr, iso-propyl; n-Pr, n-propyl; t-Bu, tert-butyl; n-Oct, 1-octyl; Cy, cyclohexyl.

The term “activator” refers to a compound that chemically reacts with a precatalyst in a manner that converts the precatalyst into a catalytically active catalyst. A nonlimiting example of an activator is methylaluminoxane.

A “bimodal polymer composition” (e.g., a bimodal ethylene/olefin copolymer composition) is a composition composed of (i) high molecular weight component (“HMW”), and (ii) low molecular weight component (LMW″), wherein the high molecular weight component consists of a first group of polymer macromolecules made by a first catalyst, and the low molecular weight component consists of a second group of polymer macromolecules made by a second catalyst, wherein at least one of the following differences are present: the catalysts are different in catalytic metal and/or ligand composition. The bimodal polymer composition may be characterized by two peaks separated by a distinguishable local minimum therebetween in a plot of dW/dlog(MW) on the y-axis versus Log(MW) on the x-axis to give a Gel Permeation Chromatograph (GPC) chromatogram, wherein Log(MW) and dW/dlog(MW) are as defined herein and are measured by Gel Permeation Chromatograph (GPC) Test Method described herein.

A “multimodal polymer composition” is a composition with a molecular weight distribution having two or more peaks as determined by GPC, wherein the two or more peaks independently can be a head and shoulder configuration or a two or more heads configuration having a local minimum (valley) therebetween. Examples of multimodal polymer compositions include bimodal polymer compositions and trimodal polymer compositions. The term “multimodal” (or “bimodal”) also refers to a catalyst that produces a composition with multimodal (or “bimodal”) molecular weight distribution.

A “catalyst” is a material that enhances rate of a reaction (e.g., the polymerization of ethylene and α-olefin, for example) and is not completely consumed thereby.

A “catalyst system” is a combination of one or more precatalysts and an activator, such as a methylaluminoxane, a support material on which the catalyst is disposed, a carrier material in which the catalyst is disposed, or a combination of any two or more thereof, or a reaction product of a reaction thereof.

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or” unless stated otherwise, refers to the listed members individually as well as in any combination.

An “ethylene-based polymer” or “ethylene polymer” is a polymer that contains a majority amount, or greater than 50 mol %, of polymerized ethylene based on the weight of the polymer, and, optionally, may comprise at least one comonomer.

An “ethylene/α-olefin copolymer” is a polymer that contains a majority amount of polymerized ethylene, based on the mole percent of the copolymer, and at least one α-olefin comonomer.

A “feed” is a quantity of reactant or reagent or other component necessary for operability of fluidization of the reactor that is added or “fed” into a reactor by way of a “feed line”. In continuous polymerization operation, each feed independently may be continuous or intermittent. The quantities or “feeds” may be measured, e.g., by metering, to control amounts and relative amounts of the various reactants and reagents in the reactor at any given time.

A “feed line” is a pipe or conduit structure for transporting a feed.

The term “heteroatom” refers to an atom other than carbon or hydrogen. Nonlimiting examples of heteroatom include F, Cl, Br, N, O, P, B, S, Si, Sb, Al, Sn, As, Se and Ge.

The term “hydrocarbyl” refers to univalent substituents containing only hydrogen and carbon atoms, including branched or unbranched, saturated or unsaturated, cyclic, polycyclic or noncyclic species. Nonlimiting examples include alkyl-, cycloalkyl-, alkenyl-, alkadienyl-, cycloalkenyl-, cycloalkadienyl-, aryl-, and alkynyl-groups. The term “substituted hydrocarbyl” refers to a hydrocarbyl group that is substituted with one or more nonhydrocarbyl substituent groups. The terms “heteroatom containing hydrocarbyl” or “heterohydrocarbyl” refer to univalent groups in which at least one atom other than hydrogen or carbon is present along with one or more carbon atom and one or more hydrogen atoms. The term “heterocarbyl” refers to groups containing one or more carbon atoms and one or more heteroatoms and no hydrogen atoms. The bond between the carbon atom and any heteroatom, as well as the bonds between any two heteroatoms, may be a single or multiple covalent bond or a coordinating or other donative bond. Thus, an alkyl group substituted with a heterocycloalkyl-, aryl-substituted heterocycloalkyl-, heteroaryl-, alkyl-substituted heteroaryl-, alkoxy-, aryloxy-, dihydrocarbylboryl-, dihydrocarbylphosphino-, dihydrocarbylamino-, trihydrocarbylsilyl-, hydrocarbylthio-, or hydrocarbylseleno-group is within the scope of the term heteroalkyl. Examples of suitable heteroalkyl groups include cyanomethyl-, benzoylmethyl-, (2-pyridyl)methyl-, and trifluoromethyl-groups.

A “metallocene catalyst” is a material that contains a metallocene precatalyst that is defined as a cyclopentadienyl ligand-metal complex and enhances olefin polymerization reaction rates. Each metal is a transition metal Ti, Zr, or Hf. Each cyclopentadienyl ligand independently is an unsubstituted cyclopentadienyl group or a hydrocarbyl-substituted cyclopentadienyl group. In some aspects the metallocene catalyst has two cyclopentadienyl ligands, and at least one, alternatively both, of the cyclopentenyl ligands independently is a hydrocarbyl-substituted cyclopentadienyl group. Each hydrocarbyl-substituted cyclopentadienyl group may independently have 1, 2, 3, 4, or 5 hydrocarbyl substituents. Each hydrocarbyl substituent may independently be a (C₁-C₄) alkyl. Two or more substituents may be bonded together to form a divalent substituent, which with carbon atoms of the cyclopentadienyl group may form a ring.

The term “molecular weight distribution” refers to a ratio of two different molecular weights of a polymer. The generic term molecular weight distribution includes a ratio of a weight average molecular weight (Mw) of a polymer to a number average molecular weight (Mₐ) of the polymer, which may also be referred to as a “molecular weight distribution (M_{w}/Mₙ),” and a ratio of a z-average molecular weight (M_{z}) of a polymer to a weight average molecular weight (M_{w}) of the polymer, which may also be referred to as a “molecular weight distribution (M_{z}/M_{w}).”

An “olefin-based polymer” or “polyolefin” is a polymer that contains a majority amount, or greater than 50 mol %, of polymerized olefin monomer, for example, ethylene or propylene, (based on the weight of the polymer), and optionally, may contain at least one comonomer. Nonlimiting examples of an olefin-based polymer include an ethylene-based polymer and a propylene-based polymer.

A “precatalyst” refers to a transition metal compound that has olefin polymerization catalytic activity when combined with an activator.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer.” A “copolymer” is a polymer having two polymer units that are different from each other. A “terpolymer” is a polymer having three or more polymer units that are different from each other. “Different” in reference to polymer units indicates that the polymer units differ from each other by at least one atom or are different isomerically.

As used herein a “polymerization process” is a process that is utilized to make a polymer. For instance, the polymerization process can be a gas-phase or slurry-phase polymerization process. In some embodiments, the polymerization process consists of a gas-phase polymerization process. In some embodiments the polymerization process consists of a slurry-phase polymerization process. Trace amounts of impurities, for example, catalyst residues, may be incorporated into and/or within the polymer. It also embraces all forms of copolymer, e.g., random, block, etc. The terms “ethylene/α-olefin copolymer” and “propylene/α-olefin copolymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

The term “supported catalyst” refers to a catalyst system made from the method of combining the activator, a support material, an inert hydrocarbon solvent, and optionally one or more precatalysts to make a mixture and removing the inert hydrocarbon solvent under reduced pressure and optionally an elevated temperature to yield a supported catalyst system particle.

The term “spray drying” refers to the method of combining the activator, a support material, an inert hydrocarbon solvent and optionally one or more precatalysts to make a mixture and removing the inert hydrocarbon solvent via spray drying from the mixture so as to yield a spray dried catalyst. A spray dried catalyst may be considered a specific case of a supported catalyst system.

A “trim catalyst” is a quantity of a precatalyst that may optionally be used in combination with a metallocene catalyst system or supported or spray dried metallocene catalyst system to create a resultant bimodal catalyst system. Trim catalyst is usually fed (e.g., to the gas phase polymerization reactor) as a solution of the catalyst dissolved in an inert liquid (non-polar, aprotic, e.g., a hydrocarbon solvent such as hexane). The trim catalyst is used to modify at least one property of the copolymer composition made thereby. Nonlimiting examples of properties modified by the trim catalyst include density, melt index I₂, flow index I₂₁, melt flow ratio, molecular mass dispersity (M_{w}/Mₙ/Mₚ/M_{z}), short chain branching distribution, and any combination thereof.

### DETAILED DESCRIPTION

### 1. Catalyst System

The present disclosure provides a catalyst system. The catalyst system includes (A) a phenoxy imine precatalyst and (B) a metallocene precatalyst. The (A) phenoxy imine precatalyst has a structure of Formula (1);

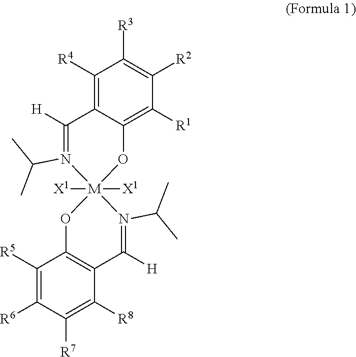

wherein
M¹ is a metal selected from the group consisting of Ti, Zr, and Hf;
each X¹ is independently a halogen atom;
R¹ and R⁵ each is independently selected from the group consisting of a substituted (C₁-C₂₀) hydrocarbyl, an unsubstituted (C₁-C₂₀)hydrocarbyl, a substituted (C₁-C₂₀)heterohydrocarbyl, and a substituted (C₁-C₂₀) heterohydrocarbyl;
R³ and R⁷ each is independently selected from the group consisting of a substituted (C₁-C₂₀) hydrocarbyl, an unsubstituted (C₁-C₂₀)hydrocarbyl, a substituted (C₁-C₂₀) heterohydrocarbyl, and a substituted (C₁-C₂₀)heterohydrocarbyl; and
R², R⁴, R⁶, and R⁸ each is hydrogen.
(B) The metallocene precatalyst has a structure of Formula 2:

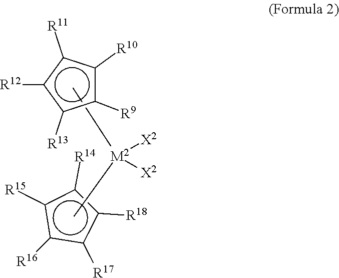

wherein
M² is a metal selected from the group consisting of Ti, Zr, and Hf;
each X² is independently selected from the group consisting of a (C₁-C₁₀) heterohydrocarbyl and a halogen atom;
R⁹, R¹⁰, R¹¹, R¹², R¹, R¹⁴, R¹⁵, R¹⁶, R¹⁷, and R¹⁸ each is independently selected from the group consisting of a substituted (C₁-C₁₀)hydrocarbyl, an unsubstituted (C₁-C₁₀)hydrocarbyl, a substituted (C₁-C₁₀)heterohydrocarbyl, an unsubstituted (C₁-C₁₀)heterohydrocarbyl, and hydrogen with the proviso that any two adjacent of R⁹-R¹³ may be optionally connected to form a ring structure and any two adjacent of R¹⁴-R¹⁸ may be optionally connected to form a ring structure.

The catalyst system includes (A) the phenoxy imine precatalyst. The phenoxy imine precatalyst has the structure of Formula 1 as disclosed above.

In an embodiment, the phenoxy precatalyst has the structure of Formula 1A:

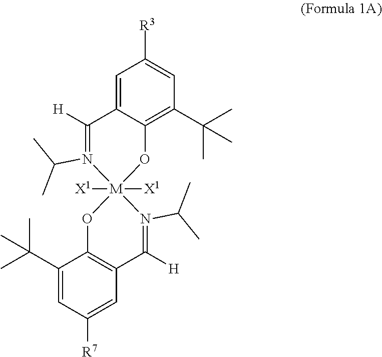

wherein
M¹ is a metal selected from the group consisting of Ti, Zr, and Hf,
R³ and R⁷ each is independently a C₈ to C₂₀ alkyl group, and
each X¹ is independently a halogen atom.

In an embodiment, each of R³ and R⁷ in the structure of Formula 1A, independently is a C₈ alkyl group. The C₈ alkyl group for each of R³ and R⁷ is independently selected from n-octyl and 2,2′,4,4′-tetramethylbutyl. In a further embodiment, the phenoxy imine precatalyst has the structure of Formula 1B below:

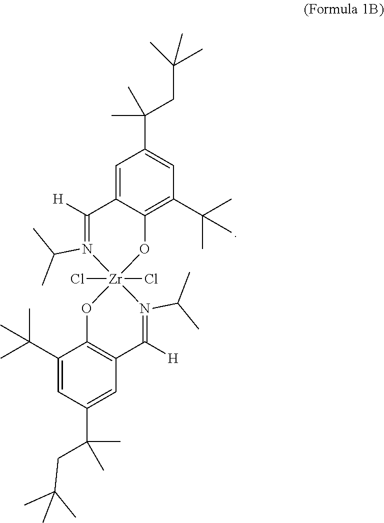

In an embodiment, each of R³ and R⁷ in the structure of Formula 1A, independently is a C₈ alkyl group. In a further embodiment, the phenoxy imine precatalyst has the structure of Formula 1C below:

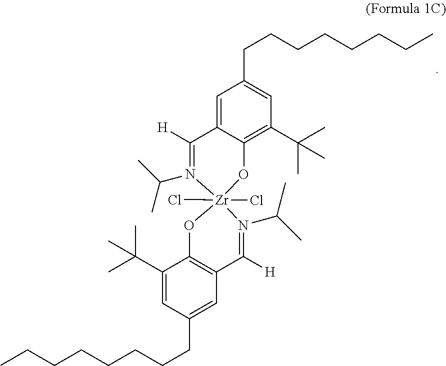

The catalyst system includes (B) the metallocene precatalyst. The metallocene precatalyst (B) has the structure of Formula (2) as disclosed above. In an embodiment, the metallocene precatalyst (B) has the structure of Formula (2B) below:

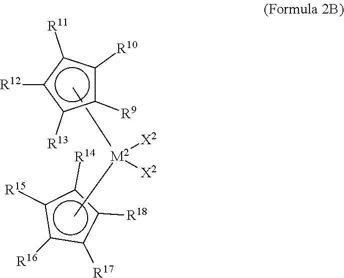

wherein M² is a metal selected from the group consisting of Zr and Hf;
each X² is independently selected from the group consisting of a (C₁-C₄) hydrocarbyl and a halogen atom;
R⁹, R¹¹, R¹³, R¹⁴, R¹¹, and R¹⁷ each is hydrogen; and
R¹⁰, R¹², R¹⁵, and R¹⁸ each is independently selected from a (C₁-C₄) hydrocarbyl. Nonlimiting examples of suitable metallocene precatalysts with the Structure (2B) include the metallocene precatalyst with the structure of Formula (2B-1) and/or the metallocene precatalyst with the structure of Formula (2B-2) as provided below:

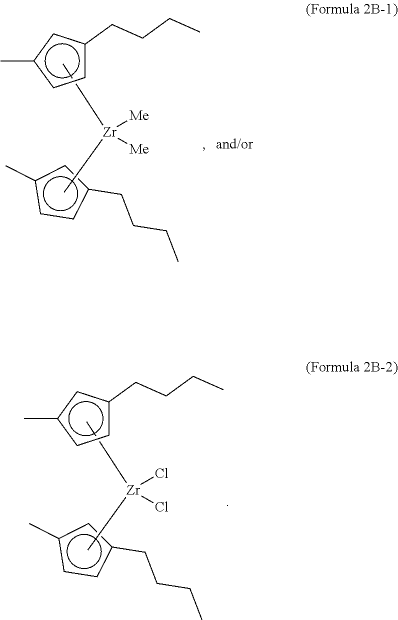

In an embodiment, the metallocene precatalyst (B) has the structure of Formula (2) below:

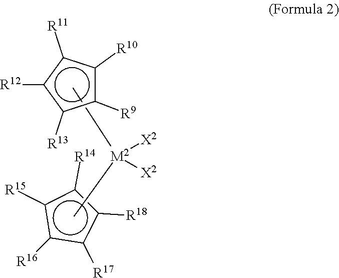

wherein M² is a metal selected from the group consisting of Zr and Hf;
each X² is independently selected from the group consisting of a (C₁-C₄) hydrocarbyl and a halogen atom;
R⁹, R¹¹, R¹², R¹³, R¹⁴, R¹⁵, R¹⁶, R¹⁷ each is hydrogen; and
R¹⁰ and R¹⁸ each is independently selected from a (C₁-C₄) hydrocarbyl. Nonlimiting examples of suitable metallocene precatalysts with the Structure (2) include the metallocene precatalyst with the structure of Formula (2B-3) and/or the metallocene precatalyst with the structure of Formula (2B-4) as provided below:

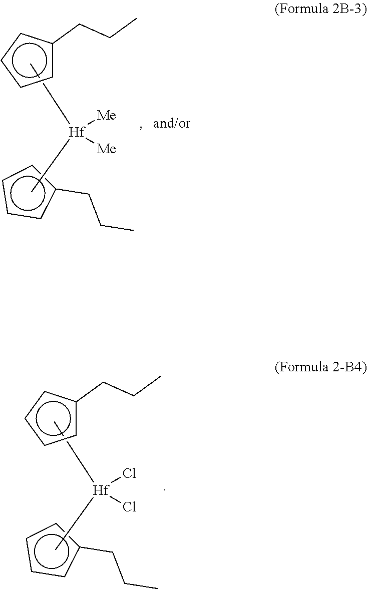

In an embodiment, the metallocene precatalyst (B) has the structure of Formula (2B-3) below:

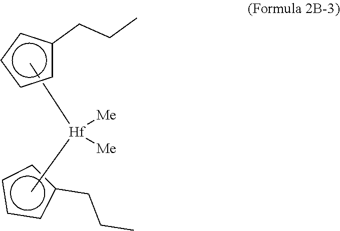

In an embodiment, the catalyst system also includes an activator (C) in addition to (A) the phenoxy imine precatalyst with structure of Formula (1) and (B) the metallocene precatalyst with structure of Formula (2). As used herein, “activator” refers to a compound or combination of compounds, supported, or unsupported, which can activate a complex or a precatalyst component, such as by creating a cationic species of the precatalyst component. For example, this can include the abstraction of at least one leaving group, e.g., from the metal center of the complex/catalyst component, e.g., the metal complex of Formula 1 and/or Formula 2. As used herein, “leaving group” refers to one or more chemical moieties bound to a metal atom and that can be abstracted by an activator, thus producing a species active towards olefin polymerization.

The activator can include a Lewis acid or a non-coordinating ionic activator or ionizing activator, or any other compound including Lewis bases, aluminum alkyls, and/or conventional-type co-catalysts. Nonlimiting examples of activator include methylaluminoxane (“MAO”) and modified methylaluminoxane (“MMAO”). Further nonlimiting examples of activator include aluminoxane or modified aluminoxane, and/or ionizing compounds, neutral or ionic, such as dimethylanilinium tetrakis(pentafluorophenyl)borate, triphenylcarbenium tetrakis(pentafluorophenyl)borate, dimethylanilinium tetrakis(3,5-(CF₃)₂phenyl)borate, Triphenylcarbenium tetrakis(3,5-(CF₃)₂phenyl)borate, dimethylanilinium tetrakis(perfluoronapthyl)borate, triphenylcarbenium tetrakis(perfluoronapthyl)borate, dimethylanilinium tetrakis(pentafluorophenyl)aluminate, triphenylcarbenium tetrakis(pentafluorophenyl)aluminate, dimethylanilinium tetrakis(perfluoronapthyl)aluminate, triphenylcarbenium tetrakis(perfluoronapthyl)aluminate, a tris(perfluorophenyl)boron, a tris(perfluoronaphthyl)boron, tris(perfluorophenyl)aluminum, a tris(perfluoronaphthyl)aluminum or any combinations thereof.

In an embodiment, the activator is an aluminoxane. An “aluminoxane” is an oligomeric aluminum compound having —Al(R)-O— subunits, where R is an alkyl group. Aluminoxanes can be produced by the hydrolysis of the respective trialkylaluminum compound. MMAO can be produced by the hydrolysis of trimethylaluminum and a higher trialkylaluminum, such as triisobutylaluminum. There are a variety of known methods for preparing aluminoxane and modified aluminoxanes. The aluminoxane can include a modified methyl aluminoxane (“MMAO”) type 3A (commercially available from Nouryon under the trade name Modified Methylaluminoxane type 3A, discussed in U.S. Pat. No. 5,041,584). A source of MAO can be a solution having from about 1 wt. % to about a 50 wt. % MAO, for example. Commercially available MAO solutions can include the 10 wt. % and 30 wt. % MAO solutions available from W. R. Grace, of Baton Rouge, LA.

One or more organo-aluminum compounds, such as one or more alkylaluminum compounds, can be used in conjunction with the aluminoxanes. Examples of alkylaluminum compounds include, but are not limited to, diethylaluminum ethoxide, diethylaluminum chloride, diisobutylaluminum hydride, and combinations thereof. Examples of other alkylaluminum compounds, e.g., trialkylaluminum compounds include, but are not limited to, trimethylaluminum, triethylaluminum (“TEAL”), triisobutylaluminum (“TiBAI”), tri-n-hexylaluminum, tri-n-octylaluminum, tripropylaluminum, tributylaluminum, and combinations thereof.

In an embodiment, the catalyst system includes (D) a support material. The support material may be a porous support material, for example, talc, an inorganic oxide, or an inorganic chloride. Other support materials include resinous support materials, e.g., polystyrene, functionalized or crosslinked organic supports, such as polystyrene divinyl benzene polyolefins or polymeric compounds, zeolites, clays, or any other organic or inorganic support material and the like, or mixtures thereof.

Support materials include inorganic oxides that include Group 2, 3, 4, 5, 13 or 14 metal oxides. Some preferred supports include silica, fumed silica, alumina, silica-alumina, and mixtures thereof. Some other supports include magnesia, titania, zirconia, magnesium chloride, montmorillonite, phyllosilicate, zeolites, talc, clays) and the like. Also, combinations of these support materials may be used, for example, silica-chromium, silica-alumina, silica-titania and the like. Additional support materials may include porous acrylic polymers, nanocomposites, aerogels, spherulites, and polymeric beads.

A nonlimiting example of a support material is fumed silica available under the trade name Cabosil™ TS-610, or other TS- or TG-series support, available from Cabot Corporation. Fumed silica is typically a hydrophobic silica with low surface area and a submicron particle size that has been treated with dimethylsilyldichloride such that a majority of the surface hydroxyl groups are capped.

In an embodiment, the support material has a surface area in the range from 10 to 700 m²/g, pore volume in the range from 0.1 to 4.0 g/cm³ and an average particle size in the range from 0.05 to 500 microns. More preferably, the surface area of the support material is in the range from 50 to 500 m²/g, pore volume from 0.5 to 3.5 g/cm³ and average particle size of from 0.05 to 50 microns. Most preferably the surface area of the support material is in the range from 50 to 300 m²/g, pore volume from 0.8 to 3.0 g/cm³ and average particle size is from 0.1 to 10 microns. The average pore size of the support material typically has pore size in the range of from 10 to 000 Angstroms (A) or from 50 to 500A, or from 75 to 350A.

The solid support material may be an uncalcined material or a calcined material prior to being contacted with the activator. The solid support material may be a hydrophobic fumed silica (e.g., a fumed silica treated with dimethyldichlorosilane). The activator spray-dried to the support may be in the form of a powdery, free-flowing particulate solid.

In an embodiment, the catalyst system includes (C) the activator that is methylaluminoxane (MAO) spray-dried with (D) a support material that is hydrophobic fumed silica. Also disposed on the support material is (A) the phenoxy imine precatalyst having the structure of Formula (1), and/or (B) the metallocene precatalyst having the structure of Formula (2). The term “disposed,” “disposed on,” and like terms refers to the physical contact between the support material (D) and the other components (A), and/or (B), and/or (C); the term “disposed on” including, but not limited to, deposited on, in contact with, vaporized with, bonded to, incorporated within, adsorbed on, and absorbed in. The activator activates the precatalysts that are present on the support material; namely, (A) the phenoxy imine precatalyst, and/or (B) the metallocene precatalyst. In this way, the catalyst system is a “supported activated bimodal catalyst system” (or “SABCS”) as will be further described below.

In an embodiment, the catalyst system is a SABCS and includes (A) the phenoxy imine precatalyst having the structure of Formula (1) (and metal M1), (B) the metallocene precatalyst having the structure of Formula (2) (and metal M2), and (C) the activator that is methylaluminoxane (MAO); (A), (B), and (C) each disposed on, or otherwise spray-dried with (D) the support material that is hydrophobic fumed silica. The molar ratio of metal (Al) in the activator to the combined metal in the phenoxy imine precursor of Formula 1 (M1) and metallocene precursor of Formula 2 (M2) is from 0.5:1 to 3,500:1, or the Al:(M1+M2) molar ratio is from 0.05:1 to 2,000:1, or from 0.5:1 to 1,000:1, or from 0.5:1 to 500:1, or from 0.5:1 to 250:1, or from 0.5:1 to 150:1, or from 0.5:1 to 100:1, or from 0.5:1 to 75:1, or from 0.5:1 to 50:1, or from 0.5:1 to 25:1, or from 0.5:1 to 10:1.

### 2. Process for Producing Supported Activated Catalyst System

The present disclosure provides a process for producing a supported activated catalyst system. The process includes providing a mixture composed of an activator and a support material suspended in an inert hydrocarbon liquid. The process includes adding, to the mixture, a precatalyst selected from (A) a phenoxy imine precatalyst having a structure of Formula (1) and/or (B) a metallocene precatalyst having a structure of Formula (2) to form a precursor activated catalyst slurry (PACS). The process includes spray drying the PACS and forming particles of a supported activated catalyst system (SACS).

The process includes providing a mixture composed of an activator and a support material suspended in an inert hydrocarbon liquid. The activator and the support material are combined, blended, or otherwise mixed with the inert hydrocarbon liquid to form the mixture. Nonlimiting examples of suitable inert hydrocarbon liquid include hexane and/or toluene.

The process includes adding a precatalyst to the mixture. The precatalyst can be (A) the phenoxy imine precatalyst having the structure of Formula (1), (B) the metallocene precatalyst having the structure of Formula (2), and combinations thereof. The precatalyst(s) are combined, blended, or otherwise mixed with the mixture to form a precursor activated catalyst slurry (or “PACS”). Combining or otherwise contacting the precatalyst(s) with the activator catalytically activates the precatalyst(s).

The process includes spray-drying the slurry and forming a spray-dried, supported activated bimodal catalyst system (SD-SABCS). The spray drying removes the hydrocarbon liquid, thereby drying the mixture and producing solid particles of support material upon which the activated catalyst system is disposed and is composed of the activator (C), precatalyst (A) and/or precatalyst (B).

In an embodiment, the process includes combining (B) the metallocene precatalyst of Formula (2) to the mixture of (C) the activator, (D) the support material suspended in an inert hydrocarbon liquid to form a precursor activated catalyst slurry. The process includes spray drying the precursor activated catalyst slurry to produce particles of a spray-dried supported activated catalyst composed of (B) the metallocene precatalyst of Formula (2) (C) the activator, and (D) the support material (hereafter referred to as “spray-dried supported activated metallocene catalyst system,” or “SD-SAMCS”). The process includes contacting (A) the phenoxy imine precatalyst of Formula 1, with the spray-dried supported activated metallocene catalyst “SD-SAMCS.” The (A) phenoxy imine precatalyst is dissolved in an inert liquid (such as hexane for example) and/or mineral oil. The phenoxy imine precatalyst is present from 0.001 wt % to 4.0 wt %, or from 0.001 wt % to 1.5 wt %, or from 0.001 to 1.0 wt %, or from 0.005 wt % to 1.0 wt %, or from 0.01 wt % to 1.0 wt %, or from 0.02 wt % to 1.0 wt %, or from 0.04 wt % to 1.0 wt %, wherein weight percent is based on the total weight of the phenoxy imine precatalyst and the inert liquid.

The spray-dried supported activated metallocene catalyst (“SD-SAMCS”) is mixed into an inert liquid to form a SD-SAMCS slurry. Nonlimiting examples of suitable inert liquid include mineral oil and an inert alkane solvent (such as hexane or toluene). The resulting SD-SAMCS slurry is mixed with the (A) phenoxy imine precatalyst/solvent to form an activated catalyst system composed of (A) the phenoxy imine precatalyst, and (B) spray-dried supported activated metallocene catalyst system (“SD-SABCS”). The SD-SABCS enables the phenoxy imine precatalyst (A) to become activated only when adsorbed onto the spray-dried catalyst particle and ensures that the phenoxy imine precatalyst (A) and the metallocene precatalyst (B) are on the same particle The activated catalyst system is subsequently injected into, or otherwise introduced into, the single polymerization reactor.

In an embodiment, the process includes combining (A) the phenoxy imine precatalyst of Formula (1) to the mixture of (C) the activator, (D) the support material suspended in an inert hydrocarbon liquid to form a precursor activated catalyst slurry. The process includes spray drying the precursor activated catalyst slurry to produce particles of a SD-SACS composed of (A) the phenoxy precatalyst of Formula (1), (C) the activator, (D) the support material. The process includes contacting (B) the metallocene precatalyst of Formula 2, with the spray-dried supported activated phenoxy imine catalyst in an inert hydrocarbon liquid to produce a spray-dried supported activated bimodal catalyst system (“SD-SABCS”).

In an embodiment, the process includes adding the phenoxy imine precatalyst (A) to the mixture, adding the metallocene precatalyst (B) to the mixture, and mixing to form a precursor activated catalyst slurry composed of the phenoxy imine precatalyst (A), the metallocene precatalyst (B), the activator (C) and the support material (D). The process includes spray-drying the slurry to produce particles of a spray-dried supported activated bimodal catalyst system composed of the phenoxy imine precatalyst (A), the metallocene precatalyst (B), the activator (C) disposed on the support material (D) to form the SD-SABCS. The SD-SABCS may be mixed with an inert liquid (mineral oil and/or inert alkane solvent) to form a slurry. The resultant slurry may be contacted by a trim solution consisting of either of the phenoxy imine precatalyst (A) or the metallocene precatalyst (B) dissolved in an inert alkane solvent. In this way, the ratio of the phenoxy imine precatalyst (A) to the metallocene precatalyst (B) may be adjusted. The SD-SABCS enables the phenoxy imine precatalyst (A) or the metallocene precatalyst (B) to become activated only when adsorbed onto the spray-dried catalyst particle and ensures that the phenoxy imine precatalyst (A) and the metallocene precatalyst (B) are on the same particle. The SD-SABCS unexpectedly increases productivity and improves operability because having the entire activated catalyst system on the same support material (e.g., on the same particle) ensures that the resulting polymer is inherently bimodal when the SD-SABCS is introduced into the single polymerization reactor. Applicant found that if the metallocene precatalyst (B), the phenoxy imine precatalyst (A), and the activator (C) are fed into the polymerization reactor as three separate components, the bimodality of the polymer is deteriorated, resulting in a polymer blend as opposed to a bimodal polymer reaction product.

### 3. Process

The present disclosure provides a process. In an embodiment, the process includes polymerizing ethylene, optionally with one or more α-olefins, under polymerization conditions, with an activated catalyst system. The activated catalyst system is composed of (A) the phenoxy imine compound having the structure of Formula (1), (B) the metallocene precatalyst having the structure of Formula (2), (C) an activator, and (D) a support material. The process includes forming an ethylene/α-olefin copolymer.

The term “polymerization conditions,” as used herein refers to a combination of polymerization condition parameters that may affect a polymerization reaction in a fluidized bed, gas-phase polymerization reactor (“FB-GPP reactor”) or a composition or property of a polymer composition product made thereby. The polymerization condition parameters may include reactor design and size, catalyst composition and amount; reactant composition and amount; molar ratio of different reactants; presence or absence of feed gases such as H₂, molar ratio of feed gases versus reactants, absence or concentration of interfering materials (e.g., H₂O), absence or presence of an induced condensing agent (ICA) (e.g. isopentane), average polymer residence time in the reactor, partial pressures of constituents, feed rates of monomers, reactor bed temperature (e.g., fluidized bed temperature), nature or sequence of process steps, time periods for transitioning between steps. Parameters other than those being described or changed by the process may be kept constant.

The present polymerization conditions utilize a gas-phase polymerization (GPP) reactor, such as a stirred-bed gas phase polymerization reactor (SB-GPP reactor) or a fluidized-bed gas-phase polymerization reactor (FB-GPP reactor), to make the polymer composition. For example, the FB-GPP reactor/method may be as described in U.S. Pat. Nos. 3,709,853; 4,003,712; US 4,011,382; U.S. Pat. Nos. 4,302,566; 4,543,399; 4,882,400; 5,352,749; US 5,541,270; EP-A-0 802 202; and Belgian Patent No. 839,380. These SB-GPP and FB-GPP polymerization reactors and processes either mechanically agitate or fluidize by continuous flow of gaseous monomer and diluent the polymerization medium inside the reactor, respectively. Other useful reactors/processes contemplated include series or multistage polymerization processes such as described in U.S. Pat. Nos. 5,627,242; 5,665,818; 5,677,375; EP-A-0 794 200; EP-B1-0 649 992; EP-A-0 802 202; and EP-B-634421.

In operating the present polymerization conditions the following polymerization condition parameters can be adjusted and/or controlled in a GPP, SB-GPP, or FB-GPP. Individual flow rates of ethylene (“C₂”), hydrogen (“H₂”) and α-olefin (such as 1-hexene (“C₆”)) are controlled to maintain a fixed comonomer to ethylene monomer gas molar ratio (C₆/C₂) equal to a described value (e.g., 0.0001-0.08), a constant hydrogen to ethylene gas molar ratio (“H₂/C₂”) equal to a described value (e.g., 0-0.1), and a constant ethylene (“C₂”) partial pressure equal to a described value (e.g., 40-240 psi). Concentrations of gases can be measured by an in-line gas chromatograph to maintain the composition in the recycle gas stream. A reacting bed of growing polymer particles is maintained in a fluidized state by continuously flowing a make-up feed and recycle gas through the reaction zone. The FB-GPP reactor is operated at a total pressure of 100 to 600 pounds per square inch-gauge (psig)) and at a described first reactor bed temperature (“RBT”). The fluidized bed is maintained at a constant height by withdrawing a portion of the bed at a rate equal to the rate of production of particulate form of the polymer composition. The product polymer composition is removed semi-continuously via a series of valves into a fixed volume chamber, wherein the removed polymer composition is purged to remove entrained hydrocarbons and treated with a stream of humidified nitrogen (N₂) gas to deactivate any trace quantities of residual catalyst.

In some embodiments the FB-GPP reactor is a commercial scale reactor such as a UNIPOL™ reactor or UNIPOL™ II reactor, which are available from Univation Technologies, LLC, a subsidiary of The Dow Chemical Company, Midland, Michigan, USA.

The polymerization conditions may further include one or more additives such as a chain transfer agent or a promoter. The chain transfer agent may be an alkyl metal such as diethyl zinc. Promoters are known, such as in U.S. Pat. No. 4,988,783 and may include chloroform, CFCl₃, trichloroethane, and difluorotetrachloroethane. Prior to reactor start up, a scavenging agent may be used to react with moisture and during reactor transitions a scavenging agent may be used to react with excess activator. Scavenging agents may be a trialkylaluminum. Gas phase polymerizations may be operated free of (not deliberately added) scavenging agents. The polymerization conditions for gas phase polymerization reactor/method may further include an amount (e.g., 0.5 to 200 ppm based on all feeds into reactor) of a static control agent and/or a continuity additive such as aluminum stearate or polyethyleneimine. The static control agent may be added to the FB-GPP reactor to inhibit formation or buildup of static charge therein.

In an embodiment, the process includes contacting the spray-dried supported activated metallocene catalyst system with the phenoxy imine precatalyst which is dissolved in hydrocarbon solvent. Contacting the spray-dried supported activated metallocene catalyst system with the phenoxy imine precatalyst (A) independently may be done either (a) in a separate vessel outside the GPP reactor (e.g., outside the FB-GPP reactor), (b) in a feed line to the GPP reactor, and/or (c) inside the GPP reactor (in situ). In option (a) the catalyst system, once the phenoxy imine precatalyst is activated, it may be fed into the GPP reactor as a slurry in mineral oil and optionally a non-polar, aprotic (hydrocarbon) solvent (i.e., a pre-mix of precatalyst and activator in hydrocarbon solvent). In option (b) a slurry of the spray dried supported activated metallocene catalyst system and the phenoxy imine precatalyst in inert hydrocarbon solvent is fed in-line to the GPP reactor. In option (c) the phenoxy imine precatalyst may be fed into the reactor prior to activation via a first feed line, and the activator may be fed into the reactor via a second feed line. The activator(s) may be fed into the reactor in “wet mode” in the form of a solution thereof in an inert liquid such as mineral oil or hexane, in slurry mode as a suspension, or in dry mode as a powder. Each contacting step may be done in separate vessels, feed lines, or reactors at the same or different times, or in the same vessel, feed line, or reactor at different times, to separately give the catalyst system. Alternatively, the contacting steps may be done in the same vessel, feed line, or reactor at the same time to give a mixture of the precatalyst and spray dried catalyst system in situ.

The process includes polymerizing, or otherwise contacting, ethylene with one or more olefins, under polymerization conditions, with the activated catalyst system composed of (A) the phenoxy imine precatalyst and the spray-dried supported activated metallocene catalyst system. As used herein, an “olefin,” refers to a linear, branched, or cyclic compound including carbon and hydrogen and having at least one double bond. As used herein, when a polymer or copolymer is referred to as comprising, e.g., being made from, an olefin, the olefin present in such polymer or copolymer is the polymerized form of the olefin. For example, when a copolymer is said to have an ethylene content of 75 wt % to 85 wt %, it is understood that the polymer unit in the copolymer is derived from ethylene in the polymerization reaction and the derived units are present at 75 wt % to 85 wt %, based upon the total weight of the polymer. A higher α-olefin refers to an α-olefin having 3 or more carbon atoms.

In an embodiment, the one or more olefins include one or more α-olefins. Nonlimiting examples of suitable α-olefins include propylene, 1-butene, 1-pentene, 1-hexene, 4-methyl-1-pentene, 1-octene, 3,5,5-trimethyl-1-hexene, and any combination thereof.

In an embodiment, polymerization of ethylene and a C₄-C₈ α-olefin comonomer is performed in a single autoclave polymerization reactor equipped with a mechanical agitator. SMAO (silica supported methyl aluminoxane) is added as a scavenger under nitrogen pressure and the reactor is subsequently charged with hydrogen. The reactor temperature is from 75° C. to 110° C. and the reactor pressure is from 200 psi to 400 psi. Once the pressurized reactor reaches a steady state, the activated catalyst system is charged to the reactor to start the polymerization. Gas molar ratios are maintained throughout the polymerization with a continuous sample stream for molar concentration measurement by a mass spectrometer. Reaction time (or residence time) may be from 0.5 hours to 7.0 hours, or from 0.5 hours to 4.0 hours, or from 1.0 hours to 3.0 hours. Upon completion of polymerization, the reactor is then cooled to ambient temperature, vented and opened.

The process includes forming a bimodal ethylene/α-olefin copolymer (or ethylene/α-olefin terpolymer). Examples of polyolefins include ethylene-based polymers, having at least 50 mol ethylene, including poly(ethylene-co-1-butene), poly(ethylene-co-1-hexene), and poly(ethylene-co-1-octene) copolymers, among others.

In an embodiment, other olefins that may be utilized include ethylenically unsaturated monomers, diolefins having 4 to 18 carbon atoms, conjugated or nonconjugated dienes, polyenes, vinyl monomers and cyclic olefins, for example. Examples of the monomers may include, but are not limited to, norbornene, norbornadiene, isobutylene, isoprene, vinylbenzocyclobutane, styrenes, alkyl substituted styrene, ethylidene norbornene, dicyclopentadiene and cyclopentene. In a number of embodiments, a copolymer of ethylene can be produced, where with ethylene, a comonomer having at least one α-olefin having from 4 to 15 carbon atoms, or from 4 to 12 carbon atoms, or from 4 to 8 carbon atoms, is polymerized, e.g., in a gas-phase polymerization process.

In an embodiment, ethylene can be polymerized with at least two different comonomers, optionally one of which may be a diene, to make a copolymer. “Optional” or “optionally” means that the subsequently described event or circumstance may or may not occur, and that the description includes instances where said event or circumstance occurs and instances where it does not.

The ethylene/α-olefin copolymer (or terpolymer) can include from 50 to 99.9 wt % of units derived from ethylene and 50-0.1 wt % of one or more olefins based on a total weight of the polymer. All individual values and subranges from 50 to 99.9 wt % are included; for example, the polymer can include from a lower limit of 50, 60, or 70 wt % of units derived from ethylene to an upper limit of 99.9, 95, 90, or 85 wt % of units derived from ethylene based on the total weight of the polymer. The polymer can include from 0.1 to 50 wt % of units derived from comonomer based on the total weight of the polymer.

In an embodiment, the polymerization conditions include a single polymerization reactor having a feed line. The feed line is in fluid communication with the interior of the polymerization reactor. The feed line is a port for introducing the catalyst system into the polymerization reactor. The process includes providing (B) the metallocene precatalyst of Formula 2, (C) the activator, and (D) the support material as a spray-dried supported activated metallocene catalyst system (SD-SAMCS). The process includes mixing the SD-SAMCS with an inert liquid (such as mineral oil) to form an SD-SAMCS slurry. The process includes providing (A) the phenoxy imine precatalyst of Formula 1 in a trim solution comprising (A) dissolved in an inert liquid (such as hexane or toluene). The process includes contacting, or otherwise mixing, the SD-SAMCS slurry with the trim solution (with precatalyst (A)) in the feed line to the polymerization reactor to form a spray-dried supported activated bimodal catalyst system (SD-SABCS). The process includes passing the SD-SABCS through the feed line and introducing the SD-SABCS into the polymerization reactor. The process includes contacting the SD-SABCS, in the polymerization reactor, with the ethylene and α-olefin and forming the bimodal ethylene/α-olefin copolymer.

In an embodiment, the polymerization conditions include a single gas-phase polymerization reactor, and the process includes contacting an activated catalyst system composed of (A) the phenoxy imine precatalyst comprising the structure of Formula (1C), the spray-dried supported activated metallocene catalyst system comprising the structure of Formula (2B-3) with the ethylene and C₄-C₈ α-olefin comonomer (i.e., 1-hexene) under polymerization conditions, and controlling, providing, or otherwise adjusting one, some, or all of the following polymerization condition parameters:
(i) a reaction temperature from 75° C. to 110° C., or from 75° C. to 105° C., or from 80° C. to 100° C., or from 80° C. to 90° C., or from 80° C. to 85° C., and/or
(ii) a molar ratio of the hydrogen gas to the ethylene of 0, or from 0.0001 to 0.0050, or from 0.0001 to 0.004, or from 0.0003 to 0.004, or from 0.0003 to 0.002, or from 0.0003 to 0.001, and/or,
(iii) a molar ratio of the 1-hexene to the ethylene of 0, or from 0.0005 to 0.080, or from 0.0010 to 0.050, or from 0.005 to 0.030, or from 0.010 to 0.03, or from 0.012 to 0.025, and/or
(iv) a reactor residence time from 0.5 hours to 7.0 hours, or from 1.0 hours to 4.0 hours, or from 1.0 to 3.0 hours, or from 1.0 to 2.0 hours, and/or
(v) an ethylene partial pressure from 100 psi to 250 psi, and/or
(vi) a reactor pressure from 200 psi to 550 psi, or from 300 psi to 400 psi, and the process includes forming a bimodal ethylene/hexene copolymer having one, some or all of the following properties:
   (i) a melting temperature (Tm) from 70° C. to 140° C.; or from 70° C. to 135° C., or from 70° C. to 130° C., or from 80° C. to 130° C. or from 90° C. to 125° C., or from 100° C. to 130° C.; and/or
   (ii) a density from 0.900 g/cc to 0.965 g/cc, or from 0.910 g/cc to 0.955 g/cc, or from 0.910 g/cc to 0.940 g/cc, or from 0.915 g/cc to 0.930 g/cc, or from 0.915 g/cc to 0.925 g/cc; and/or
   (iii) a melt index (I₂) of 0 g/10 min, or from 0.01 g/10 min to 50.0 g/10 min, or from 0.01 g/10 min to 10 g/10 min, or from 0.01 g/10 min to 5.0 g/10 min; and/or
   (iv) a high-load melt index (I₂) of 0 g/10 min, or from greater than 0 g/10 min to 300 g/10 min, or from 0.5 g/10 min to 100 g/10 min, or from 0.5 g/10 min to 50 g/10 min, or from 0.5 g/10 min to 30 g/10 min, or from 0.5 g/10 min to 15 g/10 min, or from 2 g/10 min to 15 g/10 min, or from 2 g/10 min to 10 g/10 min, or from 0.5 g/10 min to 4.0 g/10 min; and/or
   (v) a MWCDI (wt %) from 4.5 to 20.0; or from 5.0 to 15.0, or from 5.0 to 14.0; and/or
   (vi) a MWCDI (mol %) from 2 to 10, or from 2.0 to 6.0, and/or
   (vii) an MWCDI mass density split (wt %), Δₘ, from 3.0 to 20.0, or from 4.5 to 15.0, or from 5.0 to 15.0, or from 6.0 to 15.0; and/or
   (viii) a MWCDI molar density split, Δₙ, from 1.2 to 10.0, or from 2.0 to 10.0, or from 2.5 to 10.0 or from 1.5 to 6.0; and/or
   (xi) an RCIm (wt %) from 190,000 g/mol to 1,500,000 g/mol, or from 190,000 g/mol to 1,200,000 g/mol, or from 190,000 g/mol to 900,000 g/mol, or from 195,000 g/mol to 900,000 g/mol; and/or
   (x) an RCIₙ (mol %) from 70,000 g/mol to 500,000 g/mol, or from 70,000 g/mol to 350,000 g/mol, or from 75,000 g/mol to 350,000 g/mol; and/or
   (xi) a molecular mass dispersity (M_{w}/Mₙ) from 5.0 to 10.0; and/or
   (xii) a M_{z}/M_{w} from 4.0 to 12.5; and/or
   (xiii) a weight-average molecular weight (M_{w}) from 100,000 g/mol to 375,000 g/mol; and/or
   (xiv) a number-average molecular weight (Mₙ) from 15,000 g/mol to 55,000 g/mol; and/or
   (xv) a z-average molecular weight (M_{z}) from 1,000,000 g/mol to 3,000,000 g/mol.

In an embodiment, the polymerization conditions include a single gas-phase polymerization reactor, and the process includes contacting an activated catalyst system composed of (A) the phenoxy imine precatalyst having the structure comprising Formula (1C), the spray-dried supported activated metallocene catalyst system comprising Formula (2B-3) with the ethylene and C₄-C₈ α-olefin comonomer (i.e., 1-hexene) under polymerization conditions, and controlling, providing, or otherwise adjusting one, some, or all of the following polymerization condition parameters:
(i) a reaction temperature from 75° C. to 105° C., or from 80° C. to 100° C., or from 80° C. to 90° C., or from 80° C. to 85° C., and/or
(ii) a molar ratio of the hydrogen gas to the ethylene from 0.0001 to 0.0050, or from 0.0001 to 0.004, or from 0.0003 to 0.004, or from 0.0003 to 0.002, or from 0.0003 to 0.001, and/or,
(iii) a molar ratio of the hexene to the ethylene from 0.0005 to 0.050, or from 0.0010 to 0.030, or from 0.005 to 0.030, or from 0.010 to 0.03, or from 0.012 to 0.025, and/or (iv) a reactor residence time from 1.0 to 7.0 hours, or from 1.0 to 4.0 hours, or from 1.0 to 3.0 hours, or from 1.0 to 2.0 hours, and/or
(v) an ethylene partial pressure from 100 psi to 250 psi,
(vi) a reactor pressure from 200 psi to 550 psi, or from 300 psi to 400 psi, and the process includes forming a bimodal ethylene/hexene copolymer having one, some or all of the following properties:
   (i) a melting temperature (Tm) from 110° C. to 135° C., or from 115° C. to 130° C.; and/or
   (ii) a density from 0.900 g/cc to 0.935 g/cc, or from 0.910 g/cc to 0.925 g/cc; and/or
   (iii) a melt index (I₂) of 0 g/10 min, or from 0 g/10 min to 5.0 g/10 min; and/or
   (iv) a high-load melt index (I₂₁) of 0 g/10 min, or from greater than 0 g/10 min to 3.5 g/10 min; and/or
   (v) a MWCDI (wt %) from 5.0 to 15.0; and/or
   (vi) a MWCDI mass density split, Δₘ, from 4.5 to 15.0; and/or
   (vii) an RCIₘ from 195,000 g/mol to 850,000 g/mol; and/or
   (viii) a molecular mass dispersity (M_{w}/Mₙ) from 5.0 to 10.0, or from 5.5 to 9.5; and/or
   (ix) a M_{z}/M_{w} from 4.5 to 10.0; and/or
   (x) a weight-average molecular weight (M_{w}) from 250,000 g/mol to 360,000 g/mol; and/or
   (xi) a number-average molecular weight (Mₙ) from 20,000 g/mol to 55,000 g/mol; and/or
   (xii) a z-average molecular weight (M_{z}) from 1,100,000 to 2,500,000 g/mol.

The bimodal ethylene/α-olefin copolymer (or bimodal ethylene/α-olefin terpolymer) can be utilized for a number of articles such as films, fibers, nonwoven and/or woven fabrics, extruded articles, and/or molded articles, among others.

### Test Methods

BOCD/MWCDI/RCI/SCB. The comonomer distribution, or short chain branching distribution, in an ethylene/α-olefin copolymer can be characterized as either normal (also referred to as having a Zeigler-Natta distribution), reverse, or flat. Reverse comonomer distribution (rCD) is often referred to as reverse short chain branching distribution (rSCBD) or broad orthogonal composition distribution (BOCD). Several reported methods are utilized to quantify BOCD. Herein, the normal or reverse nature of the comonomer distribution can be quantified by the molecular weight comonomer distribution index (MWCDI), in which a reverse comonomer distribution is defined when the MWCDI>0 and a normal comonomer distribution is defined when the MWCDI<0. When the MWCDI=0 the comonomer distribution is said to be flat. Additionally, the MWCDI quantifies the magnitude of the comonomer distribution. Comparing two polymers that have MWCDI>0, the polymer with the greater MWCDI value is defined to have a greater, i.e., increased, BOCD; in other words, the polymer with the greater MWCDI value has a greater reverse comonomer distribution. Polymers with a relatively greater MWCDI, i.e., BOCD, can provide one or more improved physical properties, as compared to polymers having a relatively lesser MWCDI. The MWCDI is method used herein divides the GPC in half and an Mw value is calculated for each the LMW (i.e. LMW-Mw) and HMW (i.e. HMW-Mw) halves. The quantifiable value of BOCD, i.e., the MWCDI, by this method is then the slope between the wt % comonomer at the two points LMW-Mw and HMW-Mw and BOCD is defined when this slope>0 (method adapted from WO2019246069). Short chain branching (SCB) was excluded from the MWCDI calculation according to the formula 0.5>(SCBF)*(MW detector response) wherein SCBF is the SCB frequency measured in SCB/1000C. For instance, as reported in Table 2D, Inventive Example 1 (IE1) (MWCDI wt %=5.49) has an increased BOCD as compared to Comparative Sample 1 (CS1) (MWCDI wt %=3.12). Polymers with a relatively greater MWCDI, i.e., BOCD, can provide improved physical properties, such as improved film performance (i.e. improved abuse performance), as compared to polymers having a relatively lesser MWCDI.

Reverse comonomer index (“RCI”) is a method that takes the total comonomer measured in chains<Mw and subtracts them from the total comonomer measured for the chains>M_{w}. A polymer is said to be BOCD for RCI>0. There is a specified method of discarding data at signal-to-noise as described in WO 2020/046406 A1. RCI is reported in units of g/mol.

Differential Scanning Calorimetry (DSC). Melt temperature (“Tm”) is determined via Differential Scanning Calorimetry according to ASTM C 3418-08. For instance, using a scan rate of 100° C./min on a sample of 10 mg and using the second heating cycle.

Compositional conventional gel permeation chromatography (GPC) Test Method. The chromatographic system consisted of a PolymerChar GPC-IR (Valencia, Spain) high temperature GPC chromatograph equipped with an internal IR5 infra-red detector (IR5). The autosampler oven compartment was set at 160° C. and the column compartment was set at 150° C. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 g/mol and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were pre-dissolved at 80° C. with gentle agitation for 30 minutes then cooled and the room temperature solution is transferred cooled into the autosampler dissolution oven at 160° C. for 30 minutes. The polystyrene standard peak molecular weights were converted to polyethylene molecular weights using Equation 1 (as described in Williams and Ward, J. Polym. Sci., Polym. Let., 6, 621 (1968)).:

$${M}_{polyethylene} = A \times {( {M}_{polystyrene} )}^{B} \qquad ( EQ1 )$$

where M is the molecular weight, A has a value of 0.4056 and B is equal to 1.0. A fifth order polynomial was used to fit the respective polyethylene-equivalent calibration points.

The total plate count of the GPC column set was performed with decane which was introduced into blank sample via a micropump controlled with the PolymerChar GPC-IR system. The plate count for the chromatographic system should be greater than 18,000 for the 4 Agilent “Mixed A” 30 cm 20-micron linear mixed-bed columns.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° C. under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 2-4, using PolymerChar GPCONE software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ2 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ3 )$$

$${Mz}_{( GPC )} = \frac{{\sum }^{i} ( {IR}_{i} * {M}_{{polyethylene}_{i}}^{2} )}{{\sum }^{i} ( {IR}_{i} / {M}_{{polyethylene}_{i}} )} \qquad ( EQ4 )$$

To monitor the deviations over time, a flowrate marker (decane) was introduced into each sample via a micropump controlled with the PolymerChar GPC-IR system. This flowrate marker (FM) was used to linearly correct the pump flowrate (Flowrate₍ₙₒₘᵢₙₐₗ₎) for each sample by RV alignment of the respective decane peak within the sample (RV_{(FM Sample)}) to that of the decane peak within the narrow standards calibration (RV_{(FM Sample)}). Any changes in the time of the decane marker peak are then assumed to be related to a linear-shift in flowrate (Flowrate_{(effective)}) for the entire run. After calibrating the system based on a flow marker peak, the effective flowrate (with respect to the narrow standards calibration) is calculated as Equation 5. Processing of the flow marker peak was done via the PolymerChar GPCONE Software. Acceptable flowrate correction is such that the effective flowrate should be within +/−0.5% of the nominal flowrate.

$${Flowrate}_{( effective )} = {Flowrate}_{( normal )} * ( {RV}_{( FM Calibrated )} / {RV}_{( FM Sample )} ) \qquad ( EQ5 )$$

IR5 GPC Octene Composition Calibration

A calibration for the IR5 detector rationing was performed using at least ten ethylene-based polymer standards (Octene as comonomer) made by single-site metallocene catalyst from a single reactor in solution process (polyethylene homopolymer and ethylene/octene copolymers) of a narrow SCB distribution and known comonomer content (as measured by ¹³C NMR Method, Qiu et al., Anal. Chem.2009, 81, 8585-8589), ranging from homopolymer (0 SCB/1000 total C) to approximately 40 SCB/1000 total C, where total C=carbons in backbone+carbons in branches. Each standard had a weight-average molecular weight from 36,000 g/mole to 126,000 g/mole measured by GPC. Each standard had a molecular weight distribution (Mw/Mn) from 2.0 to 2.5. Polymer properties for the SCB standards are shown in Table A.

TABLE A
“Copolymer” Standards

| Wt % | IR5 Area | SCB/1000 | | |
|---|---|---|---|---|
| Comonomer | ratio | Total C | Mw | Mw/Mn |
| 23.1 | 0.2411 | 28.9 | 37,300 | 2.22 |
| 14.0 | 0.2152 | 17.5 | 36,000 | 2.19 |
| 0.0 | 0.1809 | 0.0 | 38,400 | 2.20 |
| 35.9 | 0.2708 | 44.9 | 42,200 | 2.18 |
| 5.4 | 0.1959 | 6.8 | 37,400 | 2.16 |
| 8.6 | 0.2043 | 10.8 | 36,800 | 2.20 |
| 39.2 | 0.2770 | 49.0 | 125,600 | 2.22 |
| 1.1 | 0.1810 | 1.4 | 107,000 | 2.09 |
| 14.3 | 0.2161 | 17.9 | 103,600 | 2.20 |
| 9.4 | 0.2031 | 11.8 | 103,200 | 2.26 |

The “IR5 Area Ratio (or “IR5_{Methyl Channel Area}/IRS _{Measurement Channel Area}”)” of “the baseline-subtracted area response of the IR5 methyl channel sensor” to “the baseline-subtracted area response of IR5 measurement channel sensor” (standard filters and filter wheel as supplied by PolymerChar: Part Number IR5_FWM01 included as part of the GPC-IR instrument) was calculated for each of the “Copolymer” standards. A linear fit of the Wt % Comonomer frequency versus the “IR5 Area Ratio” was constructed in the form of the following Equation 6:

Wt % Comonomer=A₀+[A₁×(IR5_{Methyl Channel Area}/IRS_{Measurement Channel Area})] (EQ 6)

where A₀ is the “Wt % Comonomer” intercept at an “IR5 Area Ratio” of zero, and A₁ is the slope of the “Wt % Comonomer” versus “IR5 Area Ratio” and represents the increase in the Wt % Comonomer as a function of “IR5 Area Ratio.” The IR5 area ratio is equal to the IR5 height ratio for narrow PDI and narrow SCBD standard materials.

The comonomer content, e.g., 1-hexene, incorporated in the polymers was determined by rapid FT-IR spectroscopy on the dissolved polymer in a GPC measurement. Comonomer content was determined with respect to polymer molecular weight by use of an infrared detector (an IR5 detector) in a gel permeation chromatography measurement, as described in Analytical Chemistry 2014, 86(17), 8649-8656. “Toward Absolute Chemical Composition Distribution Measurement of Polyolefins by High-Temperature Liquid Chromatography Hyphenated with Infrared Absorbance and Light Scattering Detectors” by Dean Lee, Colin Li Pi Shan, David M. Meunier, John W. Lyons, Rongjuan Cong, and A. Willem deGroot. Analytical Chemistry 2014 86 (17), 8649-8656.

Melt Indices. Melt index (“I₂”) Test Method: for ethylene-based (co)polymer is measured according to ASTM D1238, using condition B at 190° C./2.16 kg. (“I₅”) Test Method: for ethylene-based (co)polymer is measured according to ASTM D1238, using condition B at 190° C./5.16 kg. High Load Melt Index (“I₂₁”) is measured according to ASTM D1238, using condition Bat 190° C./21.6 kilograms (kg). Report results in units of grams eluted per 10 minutes (g/10 min).

### Examples

Table 1 below provides precatalyst components, used to prepare the Comparative Samples (CS) and the Inventive Examples (IE).

TABLE 1
precatalysts

| Precatalysts | Chemical name |
|---|---|
| Phenoxy imine precatalyst of Formula 1C 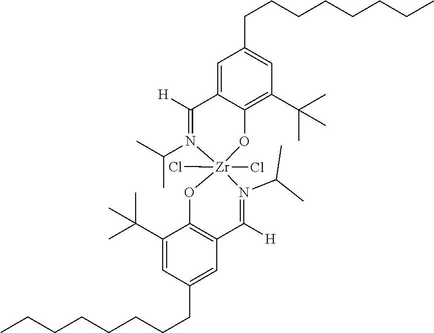 | (E)-2-(tert-butyl)-6- ((isopropylimino)methyl)-4- octylphenol Zirconium dichloride complex (Formula 1C) |
| (Formula 1C) | |
| Metallocene precatalyst 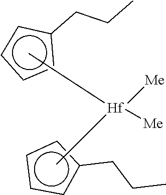 | (bis(n propylcyclopentadienyl)hafnium dimethyl (CAS 255885-01-9) (Formula 2B-3) |
| (Formula 2B-3) | |

### 2. Preparation of Spray Dried Supported Activated Metallocene Catalyst (B)

In a nitrogen-purged glovebox, 0.82 g Cabosil TS-610 hydrophobic fumed silica was slurried in 22 g toluene until well dispersed. Then 6.6 g of a 10 wt % solution of MAO in toluene was added to the slurry. Stir the mixture for 15 minutes. Then 0.021 g of Formula 2B3-3, bis(n-propylcyclopentadienyl)hafnium dimethyl (Formula 2B3-3) was added (which was obtained from the Boulder Scientific Company). The mixture was stirred for 30 to 60 minutes. The mixture was spray-dried using a 136chi Mini Spray Dryer B-290 with the following operating parameters: set temperature 140° C., outlet temperature 100° C., aspirator 50%, and pump speed 150 rotations per minute (rpm).

A spray dried activator system (SOMAC) was prepared as described above by excluding the addition of the metallocene precatalyst component.

The inventive activated catalyst system was prepared by contacting the spray dried supported activated metallocene catalyst (Formula 2B-3) with a solution of the phenoxy imine precatalyst (Formula 1C) in methylcyclohexane and allowing to mix for less than 1 hour before injecting into the single polymerization reactor. Comparative samples used either the spray-dried supported activated metallocene catalyst (2B-3) alone or SDMAO that was contacted with the phenoxy imine precatalyst (1C).

### 3. Polymerization

Polymerizations of inventive examples (IE) IE 1-5 and comparative samples (CS) CS 1-4 were conducted in gas-phase in a single polymerization reactor. The polymerization reactor was a single 2L semi-batch autoclave polymerization reactor equipped with a mechanical agitator. The single reactor was first dried for 1 hour, then charged with 200 g of sodium chloride (NaCl) and dried by heating at 100° C. under nitrogen for 1 hour. After drying, 5 grams of silica supported methylaluminoxane (SMAO) was introduced as a scavenger under nitrogen pressure. After adding the SMAO, the reactor was sealed, and components were stirred.

The single polymerization reactor was then pressurized with hydrogen. The polymerization reactor was then pressurized with hexene (at a ratio of 0.016 C₆/C₂ or a ratio of 0.023 C₆/C₂) simultaneously with ethylene (partial pressure of 220 psi). Once pressurized, the polymerization reactor was maintained at a constant C₂/H₂ and C₆/C₂ ratio as specified in table 2A below.

Once the system reached a steady state, the type and amount of respective activated catalyst system as identified in Table 2A (“Catalyst System” column in Tables 2A through 2D, “A” is phenoxy imine precatalyst of Formula 1C, “B” is the spray dried supported activated metallocene catalyst made from precatalyst of Formula 2B-3). The inventive catalyst system was prepared just prior to polymerization by contacting the spray dried supported activated metallocene catalyst made from the metallocene precatalyst of Formula 2B-3 with a 0.2 wt % solution of phenoxy imine precatalyst of Formula 1C in methylcyclohexane and allowing to mix to form a SD-SABCS before injecting into the reactor. The comparative catalysts systems used were (i) the spray dried supported activated metallocene catalyst made from the metallocene precatalyst of Formula 2B-3 (i.e. “B only” in Tables 2A-2D) and (ii) the catalyst system made similar to the inventive catalyst but where SDMAO (instead of the spray dried supported activated metallocene catalyst) was contacted with the solution of the phenoxy imine precatalyst of Formula 1C in methylcyclohexane and allowed to mix before injection into the reactor (i.e. “A only” in Tables 2A-2D). Each of the inventive examples and comparative samples were charged into the single reactor at an injection temperature of 80° C. to start polymerization. The reactor temperature was maintained at 80° C. throughout the specified residence time. At the end of the polymerization, the single polymerization reactor was cooled down, vented, and opened. The resulting product mixture was removed, washed with water and isopropanol, then dried, yielding ethylene/hexene copolymer. Individual run conditions are specified in Table 2A.

For IE1-5, 0.005 g of spray dried supported activated metallocene catalyst 2B-3 was suspended in 3 mL of methylcyclohexane. The desired quantity of the phenoxy imine precatalyst 1C (as a 0.2 wt % solution in methylcyclohexane) was added followed by 3 mL of methylcyclohexane and allowed to mix for 25 minutes before injection into the reactor. For IE1, and IE3 the quantity of phenoxy imine precatalyst 1C in the 0.2 wt % methylcyclohexane solution was 0.082 mL. For IE2 and IE4, the quantity of phenoxy imine precatalyst 1C in the 0.2 wt % methylcyclohexane solution was 0.163 mL. For IE5 the quantity of phenoxy imine precatalyst 1C in the 0.2 wt % methylcyclohexane solution was 0.245 mL.

For CS1 and CS3, 0.005 g of spray dried supported activated metallocene catalyst of Formula 2B-3 was suspended in 6 mL of methylcyclohexane and mixed for 25 minutes before injection into the reactor. For CS1 and CS3, no phenoxy imine precatalyst was used.

For CS2 and CS4, 0.005 g of SDMAO was suspended in 3 mL of methylcyclohexane. 0.245 mLof phenoxy imine precatalyst Formula 1C as a 0.2 wt % solution in methylcyclohexane was added followed by 3 mL of methylcyclohexane and allowed to mix for 25 minutes before injection into the reactor. For CS2 and CS4, no metallocene catalyst was used.

The results of polymerization activity (grams polymer/gram catalyst-hour) for IE1-5 and CS1-4 are shown in Table 2A below. Polymer properties are provided in Table 2B below.

TABLE 2A
polymerization conditions and productivity

| | | | Charge of | | | |
|---|---|---|---|---|---|---|
| | | Charge of Trim | Spray Dried | Charge of | C6/C2 | |
| Ex. | Catalyst | Precatalyst A | Metallocene | SDMAO | (molar | Productivity |
| No. | System | solution (mL)^{[a]} | B (mg) | (mg) | ratio) | (gPE/gCat) |
| CS1 | B only | 0 | 5 | 0 | 0.016 | 16191 |
| IE1 | A + B | 0.082 | 5 | 0 | 0.016 | 9019 |
| IE2 | A + B | 0.163 | 5 | 0 | 0.016 | 8120 |
| CS2 | A only | 0.245 | 0 | 5 | 0.016 | 2677 |
| CS3 | B only | 0 | 5 | 0 | 0.023 | 9706 |
| IE3 | A + B | 0.082 | 5 | 0 | 0.023 | 11917 |
| IE4 | A + B | 0.163 | 5 | 0 | 0.023 | 9271 |
| IE5 | A + B | 0.245 | 5 | 0 | 0.023 | 24195 |
| CS4 | A only | 0.245 | 0 | 5 | 0.023 | 4893 |

^{[a]}Trim solution of phenoxy imine precatalyst was made up at 0.2 wt % in methylcyclohexane. Conditions: 80° C. reaction temperature, 0.0003 H2/C2 molar ratio, 220 psi ethylene partial pressure, 1 hour run time.

TABLE 2B
Polymer Melt Flow, DSC, and GPC Characterization Data

| | | | | | | | | | | | | | Wt % | |
|---|---|---|---|---|---|---|---|---|---|---|---|---|---|---|
| | | | | | I21/ | I21/ | | | | | | | Como- | SCB/ |
| | Cat | I2 | I5 | I21 | I2 | I5 | Tm | Mn | Mw | Mz | Mw/Mn | Mz/Mw | nomer | 1000TC |
| CS1 | B only | No Flow | 0.2 | 2.366 | n/a | 11.83 | 118.34 | 49,893 | 290,519 | 2,012,799 | 5.82 | 6.93 | 7.86 | 13.10 |
| IE1 | A + B | No Flow | No Flow | No Flow | n/a | n/a | 118.81 | 50,946 | 350,489 | 2,109,197 | 6.88 | 6.02 | 10.11 | 16.85 |
| IE2 | A + B | No Flow | No Flow | 0.983 | n/a | n/a | 122.42 | 39,734 | 309,940 | 1,966,541 | 7.80 | 6.34 | 12.12 | 20.21 |
| CS2 | A only | 2.208 | 10.625 | 198.877 | 90.07 | 18.72 | 130.92 | 14,689 | 231,119 | 2,978,412 | 15.73 | 12.89 | 1.08 | 1.80 |
| CS3 | B only | 0.045 | 0.14 | 1.358 | 30.18 | 9.70 | 75.73 | 61,403 | 279,057 | 1,500,881 | 4.54 | 5.38 | 21.27 | 35.45 |
| IE3 | A + B | 0.107 | 0.332 | 3.19 | 29.81 | 9.61 | 123.91 | 43,018 | 239,894 | 1,538,754 | 5.58 | 6.41 | 18.15 | 30.25 |
| IE4 | A + B | 0.041 | 0.144 | 1.758 | 42.88 | 12.21 | | 43,395 | 229,307 | 1,131,458 | 5.28 | 4.93 | 18.79 | 31.32 |
| IE5 | A + B | 0.038 | 0.187 | 2.829 | 74.45 | 15.13 | 126.41 | 24,785 | 227,685 | 1,854,814 | 9.19 | 8.15 | 11.64 | 19.40 |
| CS4 | A only | No Flow | 0.2 | 2.366 | n/a | 11.83 | 118.34 | 13,084 | 128,099 | 2,763,700 | 9.79 | 21.57 | 1.30 | 2.16 |

TABLE 2C
Measure of Comonomer Content at Mn, Mw, LMW-Mw, and HMW-Mw

| | | | | | | | | wt % | wt % | mol % | mol % |
|---|---|---|---|---|---|---|---|---|---|---|---|
| | | wt % | wt % | mol % | mol % | LMW- | HMW- | C6 | C6 | C6 | C6 |
| Ex. | Catalyst | C6 @ | C6 @ | C6 @ | C6 @ | Mw | Mw | @LMW- | @HMW- | @LMW- | @LMW- |
| No. | System | Mn | Mw | Mn | Mw | (g/mol) | (g/mol) | Mw | Mw | Mw | Mw |
| CS1 | B only | 6.39 | 9.89 | 2.22 | 3.53 | 55137 | 328816 | 6.67 | 9.09 | 2.33 | 3.23 |
| IE1 | A + B | 7.38 | 14.05 | 2.59 | 5.17 | 59682 | 460281 | 7.61 | 12.49 | 2.68 | 4.55 |
| IE2 | A + B | 8.37 | 16.81 | 2.95 | 6.31 | 51257 | 376099 | 8.97 | 15.26 | 3.20 | 5.67 |
| CS2 | A only | 0.63 | 4.15 | 0.21 | 1.42 | 14938 | 267214 | 0.60 | 1.59 | 0.20 | 0.54 |
| CS3 | B only | 19.98 | 23.21 | 7.69 | 9.15 | 71163 | 329169 | 19.96 | 22.48 | 7.69 | 8.82 |
| IE3 | A + B | 15.29 | 21.52 | 5.68 | 8.38 | 52535 | 275015 | 15.36 | 20.97 | 5.75 | 8.13 |
| IE4 | A + B | 14.81 | 22.16 | 5.48 | 8.67 | 55572 | 295111 | 15.52 | 21.99 | 5.83 | 8.59 |
| IE5 | A + B | 4.54 | 19.38 | 1.56 | 7.42 | 29689 | 259595 | 5.55 | 17.82 | 1.94 | 6.76 |
| CS4 | A only | 0.94 | 5.24 | 0.31 | 1.81 | 14742 | 47432 | 1.01 | 1.76 | 0.34 | 0.60 |

TABLE 2D
Quantification of Polymer Density Splits and Short Chain Branching Distributions

| | | | | | | MWCDI | MWCDI | | |
|---|---|---|---|---|---|---|---|---|---|
| | | Mass | Molar | | | Mass | Molar | RCIₘ, | RCIₙ, |
| Ex. | Catalyst | Density | Density | MWCDI | MWCDI | Density | Density Split | wt % | mol % |
| No. | System | Split, Δₘ | Split, Δₙ | (wt %) | (mol %) | Split (wt %) | (mol %) | (g/mol) | (g/mol) |
| CS1 | B only | 3.50 | 1.31 | 3.12 | 1.16 | 2.42 | 0.90 | 181265 | 67610 |
| IE1 | A + B | 6.67 | 2.58 | 5.49 | 2.10 | 4.87 | 1.87 | 199610 | 77353 |
| IE2 | A + B | 8.44 | 3.36 | 7.26 | 2.85 | 6.28 | 2.47 | 406340 | 158826 |
| CS2 | A only | 3.52 | 1.21 | 0.78 | 0.27 | 0.98 | 0.33 | 93046 | 31657 |
| CS3 | B only | 3.23 | 1.47 | 3.79 | 1.70 | 2.52 | 1.13 | 98930 | 44549 |
| IE3 | A + B | 6.23 | 2.70 | 7.80 | 3.31 | 5.61 | 2.38 | 371281 | 157518 |
| IE4 | A + B | 7.35 | 3.19 | 8.92 | 3.80 | 6.47 | 2.76 | 470701 | 200335 |
| IE5 | A + B | 14.84 | 5.86 | 13.04 | 5.11 | 12.28 | 4.82 | 845605 | 334619 |
| CS4 | A only | 4.31 | 1.50 | 1.49 | 0.51 | 0.76 | 0.26 | 16783 | 5762 |

Δₘ, or mass density split, is defined as the difference in the wt % comonomer between M_{w} and Mₙ, and given by the equation:

$${Δ}_{m} = ( wt . \% hexene at Mw ) - ( wt . \% hexene at Mn )$$

Δₙ, or molar density split, is defined as the difference in the mol % comonomer between M_{w} and Mₙ, and given by the equation:

$${Δ}_{n} = ( mol \% hexene at Mw ) - ( mol \% hexene at Mn )$$

The MWCDI has been defined previously and is given in both wt % and mol % values.

The MWCDI density split with the difference in comonomer content of between the HMW-M_{w} and LMW-M_{w} and is given in both wt % and mol %.

RCI is a method that takes the total comonomer measured in chains<Mw and subtracts them from the total comonomer measured for the chains>Mw. A polymer is said to be BOCD for RCI>0. There is a specified method of discarding data at signal-to-noise as described in WO 2020/046406 A1. RCI reported in units of g/mol.

IE1-2 are made by the bimodal catalysts composed of the spray-dried supported activated metallocene catalyst of Formula 2B-3 and the phenoxy imine of Formula 1C and are made at the same reactor and feed conditions with differing ratios of 1C to 2B-3. Comparative samples use only the spray-dried supported activated metallocene 2B-3 (i.e., CS1) or phenoxy imine Cl disposed onto SDMAO (i.e., CS2). IE1-2 are no flow bimodal polymers with Mw of ca. 310 and 350 kg/mol and Mw/Mn of 6.88 and 7.80 and Mz/Mw>6 but<12 (Table 2B).

Significantly, the IE1-2 bimodal polymers have improved BOCD or reverse SCBD character as shown by MWCDI (wt %) of 5.49 and 7.26 compared to 3.12 and 0.78 for comparative samples CS1 and CS2, respectively. Alternatively, these MWCDI values given in mol % as 2.10 and 2.85 for IE1 and IE2, and 1.16 and 0.27 for CS1 and CS2, respectively. The BOCD character for IE1-2 polymers is also well described by the density splits in either wt % or mol % comonomer, where IE1-2 have values of 6.67 wt % (2.58 mol %) and 8.44 wt % (3.36 mol %) compared to 3.50 wt % (1.31 mol %) and 3.52 wt % (1.21 mol %) for CS1 and CS2.

Similarly, the density splits can be quantified using the same LMW-Mw and HMW-Mw values used to calculate the MWCDI to give “MWCDI density splits”: IE1-2 have values of 4.87 wt % (1.87 mol %) and 6.28 wt % (2.47 mol %) compared to 2.42 wt % (0.90 mol %) and 0.98 wt % (0.33 mol %) for CS1 and CS2. Additionally, the RCIₘ (wt %) for IE1-2 is 199.6 and 406.3 kg/mol, and for the comparative samples CS1 and CS2 values of 181.2 kg/mol and 93.0 kg/mol the comparatives (or for RCIₙ (mol %) 77.4 kg/mol and 158.8 kg/mol for IE1 and IE2 while 67.6 kg/mol and 31.7 kg/mol for CS1 and CS2). The IE1-2 bimodal polymers have greater reverse SCBD or BOCD than either CS1-2 under these conditions. The metallocene used for comparative CS1 is also used to make commercial resins having BOCD and thus is an apt comparison to the industry leading single reactor BOCD catalyst option. Additionally, IE2 has more of the phenoxy imine precatalyst C₁ resulting in a more BOCD polymer and lower Mw than IE1.

At a different set of polymerization conditions IE3-5 are made by the bimodal catalysts composed of the spray-dried supported activated metallocene catalyst of Formula 2B-3 and differing amounts of a of the phenoxy imine precatalyst of Formula 1C, IE3-5 are made at the same reactor and feed conditions with differing ratios of 1C to 2B-3. Comparative samples use only the spray-dried supported activated metallocene 2B-3 (i.e., CS3) or only phenoxy imine precatalyst 1C disposed onto SDMAO (i.e., CS4), IE3-5 are no flow bimodal polymers with Mw from 227 to 240 kg/mol and Mw/Mn from 5.28 to 9.19, and Mz/Mw from 4.93 to 8.15 (Table 2B). Significantly, IE3-5 bimodal polymers have improved BOCD or reverse SCBD character as shown by MWCDI from 7.80 to 13.04 wt % (or 3.31 to 5.11 mol %) for IE3-5 compared to 3.79 wt % (1.70 mol %) and 1.49 wt % (0.51 mol %) for comparative samples CS3 and CS4, respectively. The BOCD character for IE3-5 copolymers is also well described by the density splits in either wt % or mol % comonomer, where IE3-5 have values from 6.23 wt % (2.70 mol %) to 14.84 wt % (5.86 mol %) compared to 3.23 wt % (1.47 mol %) and 4.31 wt % (1.50 mol %) for CS2 and CS4. Similarly, the density splits can be quantified using the same LMW-Mw and HMW-Mw values used to calculate the MWCDI to give “MWCDI density splits”: IE3-5 have values from 5.61 wt % (2.38 mol %) to 12.28 wt % (4.82 mol %) compared to 2.52 wt % (1.13 mol %) and 0.76 wt % (0.26 mol %) for CS3 and CS4. Additionally, the RCIₘ (wt %) for IE3-5 from 371.3 to 845.6 kg/mol, and for the comparative samples CS3 and CS4 values of 98.9 kg/mol and 16.8 kg/mol the comparative samples (or for RCIₙ (mol %) from 157.5 to 334.6 kg/mol for IE3-5 compared to 44.5 kg/mol and 5.8 kg/mol for CS3 and CS4, respectively). The IE3-5 bimodal copolymers have greater reverse SCBD or BOCD than either comparative sample under these conditions. Additionally, IE3-5 have increasing phenoxy imine precatalysts (i.e. IE5>IE4>IE3) resulting in a more BOCD polymer with each increase in M_{w} while keeping a reasonably similar than IE1. This also demonstrates an ability to control the amount of BOCD at a given M_{w} with the inventive catalyst system by manipulating the amount of phenoxy imine precatalyst solution added.

It is specifically intended that the present disclosure is not limited to the embodiments and illustrations contained herein but include modified forms of those embodiments including portions of the embodiments and combination of elements of different embodiments as come within the scope of the following claims.

1. A catalyst system comprising:
(A) a phenoxy imine precatalyst having a structure of Formula 1: 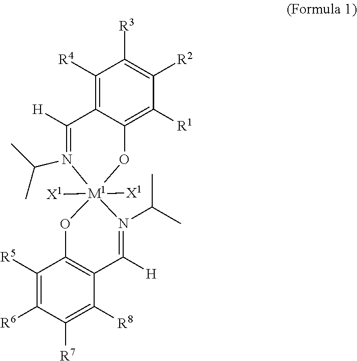
wherein
M¹ is a metal selected from the group consisting of Ti, Zr, and Hf;
each X¹ is independently a halogen atom;
R¹ and R⁵ each is independently selected from the group consisting of a substituted (C₁-C₂₀)hydrocarbyl, an unsubstituted (C₁-C₂₀)hydrocarbyl, a substituted (C₁-C₂₀)heterohydrocarbyl, and a substituted (C₁-C₂₀)heterohydrocarbyl;
R³ and R¹each is independently selected from the group consisting of a substituted (C₁-C₂₀)hydrocarbyl, an unsubstituted (C₁-C₂₀)hydrocarbyl, a substituted (C₁-C₂₀)heterohydrocarbyl, and a substituted (C₁-C₂₀)heterohydrocarbyl; and
R², R⁴, R⁶, and R⁸ each is hydrogen; and
(B) a metallocene precatalyst having a structure of Formula 2: 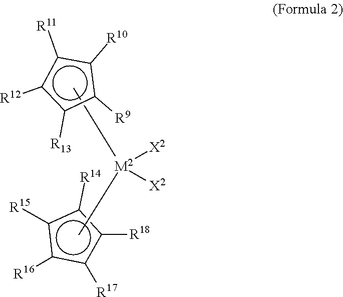
wherein
M² is a metal selected from the group consisting of Ti, Zr, and Hf;
each X² is independently selected from the group consisting of a (C₁-C₁₀)heterohydrocarbyl and a halogen atom;
R⁹, R¹⁰, R¹¹, R¹², R¹³, R¹⁴, R¹⁵, R¹⁶, R¹⁷, and R¹⁸ each is independently selected from the group consisting of a substituted (C₁-C₁₀)hydrocarbyl, an unsubstituted (C₁-C₁₀)hydrocarbyl, a substituted (C₁-C₁₀)heterohydrocarbyl, an unsubstituted (C₁-C₁₀)heterohydrocarbyl, and hydrogen with the proviso that any two adjacent of R⁹-R¹³ may be optionally connected to form a ring structure and any two adjacent of R¹⁴-R⁸ may be optionally connected to form a ring structure.

2. The catalyst system of claim 1, wherein in the phenoxy imine precatalyst has a structure of Formula 1A 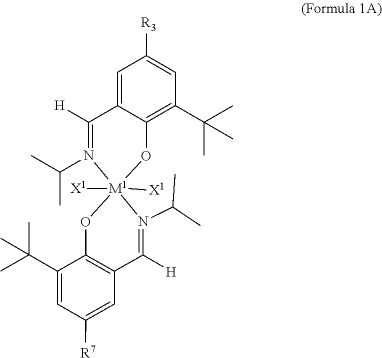
wherein
M¹ is a metal selected from the group consisting of Ti, Zr, and Hf;
R³ and R¹each is independently a C₅ to C₂₀ alkyl group, and
each X is independently a halogen atom.

3. The catalyst system of claim 2, wherein in the structure of Formula 1A, each of R³ and R¹independently is a C₈ alkyl group.

4. The catalyst system of claim 1 wherein the phenoxy imine precatalyst has a structure of Formula 1C

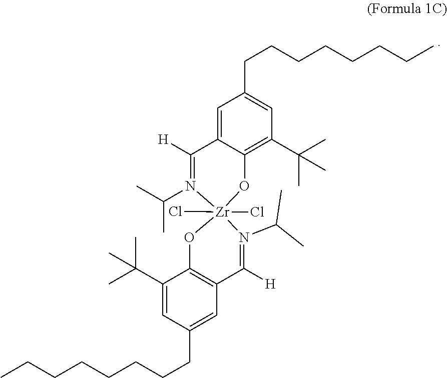

5. The catalyst system of claim 1, wherein in the metallocene precatalyst (B) having the structure of Formula 2,
M² is selected from the group consisting of zirconium and hafnium; and
each X² is independently selected from the group consisting of a methyl group and a chlorine atom.

6. The catalyst system of claim 1 wherein the metallocene precatalyst (B) has a structure selected from the group consisting of Formula (2B-1), Formula (2B-2), Formula (2B-3), and Formula (2B-4) below

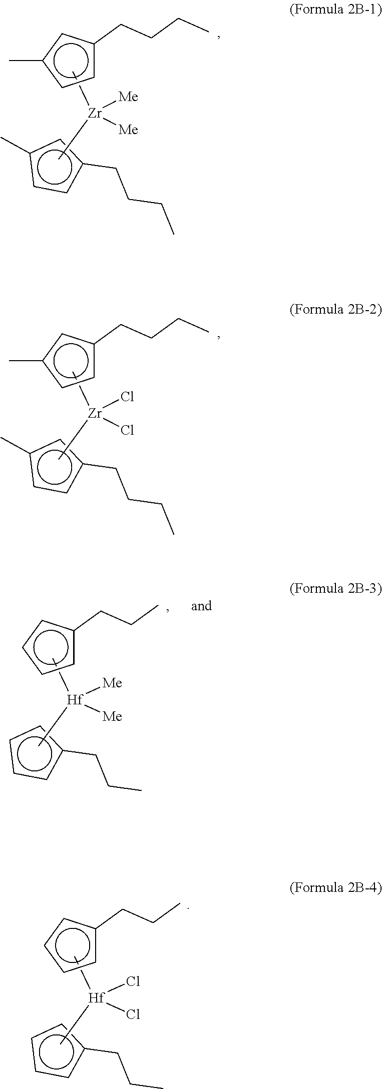

7. The catalyst system of claim 1, wherein
(A) the phenoxy imine catalyst has the structure of Formula 1C 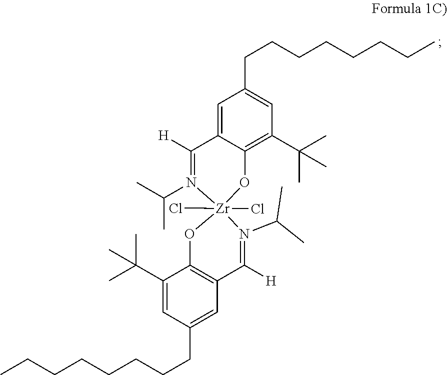
(B) the metallocene precatalyst has the structure of Formula 2B-3

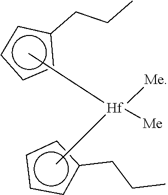

8. The catalyst system of claim 1, comprising
(C) an activator.

9. The catalyst system of claim 8 comprising
(D) a support material; and
disposed on the support material is the activator (C), and a member selected from the group consisting of (A) the phenoxy imine precatalyst of Formula 1, (B) the metallocene precatalyst of Formula 2, and combinations thereof.

10. The catalyst system of claim 9 comprising
(A) the phenoxy imine precatalyst of Formula 1C;
(B) the metallocene precatalyst of Formula 2B-3;
(C) the activator is methylaluminoxane (MAO);
(D) the support material comprising fumed silica; and
the molar ratio of metal in the activator to the combined metal in the phenoxy imine precatalyst of Formula 1C and metallocene precatalyst of Formula 2B-3 is from 0.5:1 to 3,500:1.

11. A process for producing a supported catalyst system comprising:
providing a mixture comprising an activator and a support material suspended in an inert hydrocarbon liquid;
adding to the mixture (B) a metallocene precatalyst having a structure of Formula (2), to form a precursor activated catalyst slurry (PACS);
spray drying the PACS and forming particles of a spray-dried supported activated metallocene catalyst system (SD-SAMCS);
preparing a slurry comprising the SD-SAMCS in an inert liquid; and
contacting the SD-SAMCS slurry with a trim solution comprising (A) a phenoxy imine precatalyst having a structure of Formula (1) in an inert hydrocarbon liquid; and
forming a spray-dried supported activated bimodal catalyst system (SD-SABCS).

12. A process comprising:
polymerizing ethylene with optionally one or more α-olefins, under polymerization conditions, with an activated catalyst system comprising
(A) a phenoxy imine precatalyst having a structure of Formula 1: 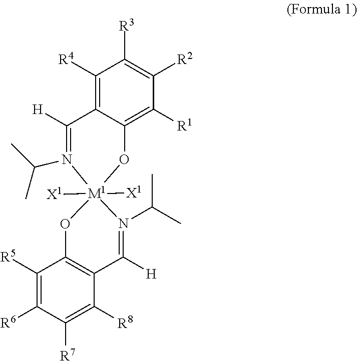
wherein
M¹ is a metal selected from the group consisting of Ti, Zr, and Hf;
each X¹ is independently a halogen atom;
R¹ and R⁵each is independently selected from the group consisting of a substituted (C₁-C₂₀)hydrocarbyl, an unsubstituted (C₁-C₂₀)hydrocarbyl, a substituted (C₁-C₂₀)heterohydrocarbyl, and a substituted (C₁-C₂₀)heterohydrocarbyl;
R³ and R¹each is independently selected from the group consisting of a substituted (C₁-C₂₀)hydrocarbyl, an unsubstituted (C₁-C₂₀)hydrocarbyl, a substituted (C₁-C₂₀)heterohydrocarbyl, and a substituted (C₁-C₂₀)heterohydrocarbyl; and
R², R⁴, R⁶, and R⁸ each is hydrogen; and
(B) a metallocene precatalyst having a structure of Formula 2 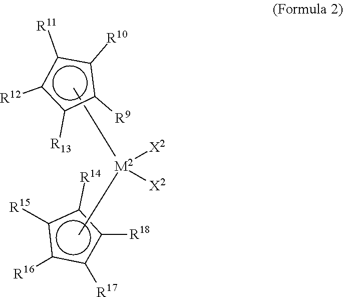
wherein
M² is a metal selected from the group consisting of Ti, Zr, and Hf;
each X² is independently selected from the group consisting of a (C₁-C₁₀)heterohydrocarbyl and a halogen atom;
R⁹, R¹⁰, R¹¹, R¹², R¹³, R¹⁴, R¹⁵, R¹⁶, R¹⁷, and R¹⁸ each is independently selected from the group consisting of a substituted (C₁-C₁₀)hydrocarbyl, an unsubstituted (C₁-C₁₀)hydrocarbyl, a substituted (C₁-C₁₀)heterohydrocarbyl, an unsubstituted (C₁-C₁₀)heterohydrocarbyl, and hydrogen with the proviso that any two adjacent of R⁹-R¹³ may be optionally connected to form a ring structure and any two adjacent of R¹⁴-R⁸ may be optionally connected to form a ring structure;
(C) an activator selected from the group consisting of aluminoxane and methylaluminoxane (MAO);
(D) a support material comprising fumed silica; and
forming a bimodal ethylene/α-olefin polymer.

13. The process of claim 12 wherein the polymerizing occurs in a single polymerization reactor.

14. The process of claim 13 wherein the polymerization conditions comprise a single polymerization reactor having a feed line, the process comprising:
providing (B), (C), and (D) as a spray-dried supported activated metallocene catalyst system (SD-SAMCS);
mixing the SD-SAMCS with an inert liquid to form an SD-SAMCS slurry;
providing (A) in a trim solution comprising (A) dissolved in an inert liquid;
contacting the SD-SAMCS slurry with the trim solution in the feed line to the polymerization reactor to form a spray-dried supported activated bimodal catalyst system (SD-SABCS);
introducing the SD-SABCS into the polymerization reactor;
contacting the SD-SABCS, in the polymerization reactor, with the ethylene and the α-olefin; and
forming a bimodal ethylene/α-olefin copolymer.

15. The process of claim 12 wherein the polymerization conditions comprise a polymerization condition parameter selected from the group consisting of
(i) a reaction temperature from 75° C. to 110° C.,
(ii) a molar ratio of hydrogen gas to the ethylene from 0 to 0.005,
(iii) a molar ratio of the α-olefin to the ethylene from 0 to 0.08,
(iv) a reactor residence time from 1.0 hours to 7.0 hours,
(v) an ethylene partial pressure from 100 psi to 250 psi,
(vi) a reactor pressure from 200 psi to 550 psi, and
(vii) combinations thereof.

16. The process of claim 12 wherein the α-olefin is present and is selected from the group consisting of (i) 1-butene, (ii) 1-hexene (iii) 1-octene, and (iv) combinations thereof, and the process comprises
forming a bimodal ethylene/α-olefin copolymer having a property selected from the group consisting of
(i) a melting temperature (Tm) from 70° C. to 135° C.,
(ii) a density from 0.900 g/cc to 0.965 g/cc,
(iii) a melt index (I₂) from 0 g/10 min to 10.0 g/10 min,
(iv) a high-load melt index (I₂₁) from 0 g/10 min to 300 g/10 min,
(v) a MWCDI (wt %) from 4.5 to 20.0,
(vi) a MWCDI (mol %) from 2.0 to 10.0,
(vii) a MWCDI mass density split, Δₘ, from 3.0 to 20.0,
(viii) a MWCDI molar density split, Δₙ, from 1.2 to 10.0,
(ix) an RCIₘ (wt %) from 190,000 g/mol to 1,500,000 g/mol,
(x) an RCIₙ (mol %) from 70,000 g/mol to 500,000 g/mol,
(xi) a molecular mass dispersity (M_{w}/Mₙ) from 5.0 to 10.0,
(xii) a M_{z}/M_{w} from 4.0 to 12.5,
(xiii) a weight-average molecular weight (M_{w}) from 100,000 g/mol to 375,000 g/mol,
(xiv) a number-average molecular weight (Mₙ) from 15,000 g/mol to 55,000 g/mol,
(xv) a z-average molecular weight (M_{z}) from 1,000,000 g/mol to 3,000,000 g/mol, and
(xvi) combinations thereof.
